(19) United States
(12) Patent Application Publication
(10) Pub. No.: US 2025/0144606 A1
(43) Pub. Date: May 8, 2025

(54) CONJUGATED POLYMERS INFILTRATED WITH INORGANICS FOR PHOTOCATALYSIS

(71) Applicant: Georgia Tech Research Corporation, Atlanta, GA (US)

(72) Inventors: Mark D. Losego, Atlanta, GA (US); Shawn Alan Gregory, Atlanta, GA (US); Li Zhang, Atlanta, GA (US)

(21) Appl. No.: 18/939,057

(22) Filed: Nov. 6, 2024

Related U.S. Application Data
(60) Provisional application No. 63/547,426, filed on Nov. 6, 2023.

(51) Int. Cl. B01J 31/06; B01J 21/06; B01J 23/06; B01J 23/28; B01J 23/745; B01J 23/755; B01J 31/28; B01J 31/34; B01J 35/39; B01J 37/02; C02F 1/32; C02F 1/72; C02F 101/30

(52) U.S. Cl. CPC B01J 31/06; B01J 21/063; B01J 23/06; B01J 23/28; B01J 23/745; B01J 23/755; B01J 31/28; B01J 31/34; B01J 35/39; B01J 37/0201; C02F 1/32; C02F 1/725; C02F 2101/308; C02F 2305/10

(57) ABSTRACT

An exemplary embodiment of the present disclosure provides a photocatalyst system. This system includes a photocatalyst comprising an organic material infused with clusters of an inorganic material diffused throughout a bulk of the organic material, wherein the organic material and the clusters of the inorganic material are configured such that the organic material photosensitizes the inorganic material. Another exemplary embodiment of the present disclosure provides a method of photocatalyzing a reaction. This method includes providing any of the photocatalysts disclosed herein; mixing the photocatalyst with a reactant to form a reaction mixture; and exposing the reaction mixture to a light source.

### CROSS-REFERENCE TO RELATED APPLICATIONS

This application claims the benefit of U.S. Provisional Patent Application Ser. No. 63/547,426, filed on Nov. 6, 2023, which is incorporated herein by reference in its entirety as if fully set forth below.

### GOVERNMENT LICENSE RIGHTS

This invention was made with government support under Agreement No. GR00004153 awarded by National Science Foundation. The government has certain rights in the invention.

### FIELD OF THE DISCLOSURE

The various embodiments of the present disclosure relate generally to conjugated polymers infiltrated with inorganics for photocatalysis.

### BACKGROUND

Conjugated polymers (CP) are of interest for flexible electronics, bioelectronics and electrochromics, among other applications. This interest derives from their mechanical flexibility and ease in engineering optical and electronic properties. To fine-tune the optical and electronic properties of CPs, altering the main chain and/or side chain chemistries, controlling crystallinity, and chemical doping of the polymer are often employed. Of these techniques, chemical doping is widely used because it enables exquisite control over the electronic and optical properties of the CPs. This doping process can be broadly categorized into vapor doping methods (e.g., dopant vapors react with the CP) and solution doping (e.g., solvents swell the CP and dopant solutes react with the CP). Vapor doping of CPs can be advantageous because there is no solvent used, mitigating polymer swelling and alterations to the polymer crystallinity, alignment, conformality, and dimensions.

Several processing methods have been studied for the vapor doping of CPs. One of these approaches is vapor phase infiltration (VPI) with inorganic precursors. VPI is a subtechnique of atomic layer deposition (ALD). However, instead of depositing ultrathin coatings on a substrate, precursors are allowed to diffuse into and react with functional groups in the bulk of the polymer.

One environmentally important application for photocatalysis is dye degradation. Proper degradation of dyes from the textile, paper and apparel industries is ecologically important because dye-contaminated waters inhibit photosynthesis and increase chemical oxygen demands for ecosystems. Photocatalysts are a promising solution to removing dyes from waste-water streams because they do not produce additional contaminants and may have long lifetimes leading to favorable economics. Among the available photocatalysts, TiOₓ has particular promise because of its low toxicity, elemental abundance, and stability.

Photoexcitation of an electron from the valence band (VB) to the conduction band (CB) enables TiOₓ photocatalysis. The bandgap for TiOₓ is about 3.2 eV, corresponding to a near ultraviolet wavelength of 387 nm. This UV light makes up only a small fraction of sunlight. Thus, to make TiOₓ photocatalysts more active in sunlight, photosensitizers are frequently introduced. Photosensitizers that absorb sunlight's more prevalent visible wavelengths can inject electrons into the conduction band of TiOₓ if electronic bands are properly aligned.

The present application is directed to overcoming these and other deficiencies in the art.

### BRIEF SUMMARY

An exemplary embodiment of the present disclosure provides a photocatalyst system. This system includes a photocatalyst comprising an organic material infused with clusters of an inorganic material diffused throughout a bulk of the organic material, wherein the organic material and the clusters of the inorganic material are configured such that the organic material photosensitizes the inorganic material.

Another exemplary embodiment of the present disclosure provides a method of photocatalyzing a reaction. This method includes providing any of the photocatalysts disclosed herein, mixing the photocatalyst with a reactant to form a reaction mixture, and exposing the reaction mixture to a light source.

In any of the embodiments disclosed herein, the photocatalyst system further comprises a light source.

In any of the embodiments disclosed herein, the organic material is infused with the inorganic material via vapor phase infiltration process.

In any of the embodiments disclosed herein, the organic material comprises a conjugated, conducting polymer.

In any of the embodiments disclosed herein, the conjugated, conducting polymer is poly(3-hexylthiophene-2,5-diyl) (P3HT).

In any of the embodiments disclosed herein, the organic material has a band gap of 1 eV to 3 eV.

In any of the embodiments disclosed herein, the inorganic material comprises a metal oxide.

In any of the embodiments disclosed herein, the metal oxide is selected from the group consisting of titanium oxide, vanadium oxide, zinc oxide, tin oxide, cerium oxide, iron (III) oxide, chromium oxide.

In any of the embodiments disclosed herein, the photocatalyst system further comprises a nanostructured surface.

In any of the embodiments disclosed herein, the photocatalyst is more photocatalytically active than either the organic material or inorganic material individually.

In any of the embodiments disclosed herein, the photocatalyst is an organic-inorganic hybrid photocatalyst.

In any of the embodiments disclosed herein, the inorganic material is at or near the surface of the organic material.

In any of the embodiments disclosed herein, the light source comprises visible light.

In any of the embodiments disclosed herein, providing the photocatalyst comprises providing an organic material, providing an inorganic material, and dosing the organic material with the inorganic material via vapor phase infiltration.

### BRIEF DESCRIPTION OF THE DRAWINGS

The following detailed description of specific embodiments of the disclosure will be better understood when read in conjunction with the appended drawings. For the purpose of illustrating the disclosure, specific embodiments are shown in the drawings. It should be understood, however, that the disclosure is not limited to the precise arrangements and instrumentalities of the embodiments shown in the drawings.

FIG. 1A provides a depiction of a VPI process that includes sorption and bulk diffusion of vapor phase inorganic precursors into the bulk of an organic polymer, in accordance with some embodiments of the present disclosure. FIG. 1B provides a proposed photocatalysis process for a P3HTTiOₓ system showing (1) visible light exciting an electron from the HOMO to the LUMO in P3HT and leaving a hole behind, (2) injection of the excited electron into the conduction band (CB) of TiOₓ, and (3) subsequent reactions of the electron with oxygen and water to create reactive species such as OH radicals that can degrade a variety of compounds, in accordance with some embodiments of the present disclosure.

FIG. 2 provides a plot of an in situ pressure profile for an entire VPI process for a 2 cycle exposure with inset showing the TiCl₄ dose and 30 s hold; 60 s vacuum; H₂O dose and 5 min hold; and, finally, 30 s vacuum, 60 s purge and 60 s vacuum for an individual cycle, in accordance with some embodiments of the present disclosure.

FIG. 3 provides a light spectrum of OSRAM HALOPAR 16 50 W 120V external bulb used in photocatalysis measurements, in accordance with some embodiments of the present disclosure. This spectrum is adapted from the manufacturer (Osram) website.

FIGS. 4A-4B provide EDX (FIG. 4A) and XPS (FIG. 4B) survey spectra collected from a ˜150 nm neat P3HT film (bottom) on glass and a ˜150 nm P3HT film on glass exposed to 5 cycles of TiCl4 VPI (top), in accordance with some embodiments of the present disclosure. Elements highlighted in gray are from the VPI treatment, and elements in black are either inherent to the polymer or part of the glass substrate (Na, Mg, Si, and Ca). FIG. 4C provides XPS depth profile of a ˜150 nm P3HT film exposed to 5 cycles of TiCl4 VPI, in accordance with some embodiments of the present disclosure.

FIG. 5 provides an XPS depth profile of a ˜150 nm P3HT film on glass exposed to 1 cycle of TiCl₄ VPI, in accordance with some embodiments of the present disclosure.

FIGS. 6A-6B provide an SEM image (FIG. 6A) and an EDX mapping (FIG. 6B) of P3HT exposed to 5 VPI cycles of TiOₓ, in accordance with some embodiments of the present disclosure.

FIGS. 7A-7H provide high-resolution XPS spectra of untreated P3HT films on glass (FIGS. 7A, 7C, 7E) and P3HT films on glass exposed to 5 cycles of TiCl₄+H₂O VPI (FIGS. 7B, 7D, 7F, 7G, 7H). Included here are XPS elemental spectra for S 2p (FIGS. 7A-7B), C 1s (FIGS. 7C-7D), O 1s (FIGS. 7E-7F), Ti 2p (FIG. 7G), and Cl 2p (FIG. 7H) with raw data (black points), appropriate deconvolutions (gray), and overall fit, in accordance with some embodiments of the present disclosure.

FIG. 8 provides Fourier Transform Infrared Spectroscopy on P3HT-TiOₓ films synthesized using 5 cycles of VPI, in accordance with some embodiments of the present disclosure.

FIGS. 9A-9C provide GIWAXS in-plane line cuts for neat P3HT and P3HT exposed to 1, 5, 7 and 10 cycles spray casted onto P-doped silicon wafers. FIGS. 9B and 9C are insets of FIG. 9A in the range of 0.1-0.45 and 1.2-1.9 Å-1, respectively, used to highlight the peak shifts from neat to the treated samples as a collective with vertical dashed line and arrows as a guide, in accordance with some embodiments of the present disclosure.

FIGS. 10A-10D provide GIWAXS nearly out-of-plane line cuts for neat P3HT and P3HT exposed to 1, 5, 7 and 10 cycles spray casted onto P-doped silicon wafers. FIGS. 10B, 10C, and 10D are insets of FIG. 10A in the range of 0.3-0.45, 0.5-1.3 and 1.5-1.9 Å-1, respectively, used to highlight the peak shifts from neat to the treated samples as a collective with vertical dashed line and arrows as a guide, in accordance with some embodiments of the present disclosure.

FIGS. 11A-11E provide GIWAXS diffractograms for neat P3HT (FIG. 11A) and P3HT exposed to 1 (FIG. 11B), 5 (FIG. 11C), 7 (FIG. 11D) and 10 (FIG. 11E) cycles spray casted onto p-doped silicon wafers, in accordance with some embodiments of the present disclosure.

FIGS. 12A-12B provide Reflective Electron Energy Loss Spectrum (REELS) Spectra of neat P3HT, ALD-deposited TiOₓ, and VPI synthesized P3HT-TiOₓ, in accordance with some embodiments of the present disclosure. FIGS. 12C-12D provide bandgap of the pure TiOₓ film (FIG. 12C) and the TiOₓ in the hybrid P3HT-TiOₓ (FIG. 12D) determined using the difference between the P3HT-TiOₓ and neat P3HT spectra, in accordance with some embodiments of the present disclosure.

FIG. 13A provides UV-vis spectra for a neat P3HT, 200 cycles (˜10.2 nm) of ALD-deposited TiO₂, and a P3HT film exposed to 5 VPI cycles of TiCl₄+H₂O, all on glass substrates, with (i, ii) relevant electronic band structure for an undoped and doped P3HT, in accordance with some embodiments of the present disclosure. FIG. 13B provides normalized photoluminescent intensity of neat P3HT and a P3HT film exposed to 5 VPI cycles of TiCl₄+H₂O on glass substrates with (i, ii) depictions of exciton generation and the subsequent relaxation or quenching, in accordance with some embodiments of the present disclosure.

FIG. 14A provides a depiction of the experimental setup used to obtain catalytic rates using degradation of methylene blue dye tracked via UV-vis spectroscopy, in accordance with some embodiments of the present disclosure. FIG. 14B provides reaction rate constants for degradation of MB using neat P3HT films on glass, 50 cycles of ALD-deposited TiO₂ films on glass, and P3HT films on glass exposed to 5 cycles of TiOₓ VPI, in accordance with some embodiments of the present disclosure. Measurements made under illumination are shown in yellow on the left, and those made in the dark are shown in black on the right.

FIGS. 15A-15C provide an example of how photocatalytic degradation rate is determined using UV-Vis spectroscopy for a control system of 50-cycle (˜2.8 nm) ALD-deposited TiO₂ film on glass, in accordance with some embodiments of the present disclosure. FIG. 15A provides UV-Vis spectra collected from a methyl blue solution containing an immersed TiOₓ photocatalyst and exposed to broadband light for varying time intervals; inset enlarges the peak absorbance. FIG. 15B provides a plot of the peak UV-Vis absorbance of the methyl blue solution over time with the latter 150 mins used for rate fitting. FIG. 15C provides a fit made to absorbance data using the first order rate law equation to obtain a k-value.

FIG. 16A provides photocatalytic rates (left, y-axis) and electrical conductivities (right, y-axis) of P3HT films on glass treated with FeTos and NOPF₆ liquid doping, 5 cycles of VPI, and 5 cycles of VPI, then hydrazine vapor dedoped, in accordance with some embodiments of the present disclosure. Note: conductivity of the dedoped sample was unmeasurable but is displayed as the lower limit of detectability for the measurement device, in accordance with some embodiments of the present disclosure. FIG. 16B provides Ti/S atomic % determined by XPS and FIG. 16C provides catalytic rate for P3HT films on glass exposed to a variety of VPI cycles, in accordance with some embodiments of the present disclosure.

FIGS. 17A-17E provide an image depicting different photocatalyst designs during a dye degradation and their design efficacies, in accordance with some embodiments of the present disclosure. FIG. 17A provides a TiOₓ photocatalyst design, FIG. 17B provides a P3HT on TiOₓ photocatalyst design, FIG. 17C provides a TiOₓ on P3HT photocatalyst design, FIG. 17D provides a P3HT with TiOₓ clusters photocatalyst design, and FIG. 17E provides a P3HT with TiOₓ clusters concentrated towards the surface photocatalyst design.

FIG. 18 provides catalytic rates of (left to right) 50 cycles of ALD-deposited TiOₓ on glass recoated with ˜150 nm P3HT, P3HT exposed to 5 cycles of VPI recoated with ˜150 nm P3HT, 50 cycles of ALD-deposited TiOₓ on glass, and P3HT exposed to 5 cycles of VPI, in accordance with some embodiments of the present disclosure.

FIG. 19 provides a comparison of other conjugated polymer-metal oxide photocatalysts used for dye degradation from the literature, in accordance with some embodiments of the present disclosure. Note: many studies were excluded from this comparison if the surface area for the catalyst could not be easily/confidently calculated.

FIGS. 20A-20B provide UV-Vis (FIG. 20A) and FTIR (FIG. 20B) of P3HT exposed to 5 VPI cycle of TiCl₄+H₂O before and after a 4-hour water submersion under illumination, in accordance with some embodiments of the present disclosure. FIG. 20C provides consecutive catalytic tests of a P3HT-TiOₓ hybrid film, in accordance with some embodiments of the present disclosure.

### DETAILED DESCRIPTION

To facilitate an understanding of the principles and features of the present disclosure, various illustrative embodiments are explained below. The components, steps, and materials described hereinafter as making up various elements of the embodiments disclosed herein are intended to be illustrative and not restrictive. Many suitable components, steps, and materials that would perform the same or similar functions as the components, steps, and materials described herein are intended to be embraced within the scope of the disclosure. Such other components, steps, and materials not described herein can include, but are not limited to, similar components or steps that are developed after development of the embodiments disclosed herein.

Disclosed herein is a new organic-inorganic hybrid material composed of a conjugated, conducting polymer infiltrated with inorganic clusters of just a few atoms in size that perform as photocatalysts. These photocatalysts can be used to drive chemical reactions or chemical decompositions used for applications ranging from decontamination to chemical fuel production. The key features of this invention are that the conjugated polymer acts as a light absorber that donates photo-excited electrons to the infiltrated inorganic clusters that then use these electrons to drive catalytic reactions. This photocatalyst architecture differs from prior art in that it uses an infiltration process to create atomic-scale inorganic clusters and not inorganic nanoparticles. These clusters can be more reactive toward specific reactions and more widely distributed across the surface to create more reaction sites. This approach also enables near-surface loading of the inorganic which is essential to create the needed exposure between the catalytic sites and the reactant species. The inventors demonstrate feasibility using a prototypical system of poly(3-hexylthiophene-2,5-diyl) (P3HT) infiltrated with both titanium oxide clusters and vanadium oxide clusters. These hybrid catalysts are demonstrated to significantly outperform control samples of pure polymer or pure inorganic and perform better than any known polymer-inorganic reported in the available literature.

Herein, inventors report for the first time the use of vapor phase infiltration (VPI) to infuse conducting polymers with inorganic metal oxide clusters that together form a photocatalytic material. While vapor infiltration has previously been used to electrically dope conjugated polymers, this is the first time that the resultant hybrid material has been demonstrated to have photocatalytic properties. The system studied is poly(3-hexylthiophene-2,5-diyl) (P3HT) vapor infiltrated with TiCl₄ and H₂O to create P3HT-TiOₓ organic-inorganic hybrid photocatalytic materials. Poly(3-hexylthiophene) (P3HT), with a band gap of about 1.9 eV (652 nm), is well-positioned to perform as a good photosensitizer for TiOₓ. X-ray photoelectron spectroscopy (XPS) analysis shows that P3HT-TiOₓ VPI films consist of a partially oxidized P3HT matrix, and the infiltrated titanium inorganic is in a 4⁺ oxidation state with mostly oxide coordination. Upon visible light illumination, these P3HT-TiOₓ hybrids degrade methylene blue dye molecules. The P3HT-TiOₓ hybrids are 4.6× more photocatalytically active than either the P3HT or TiO₂ individually or when sequentially deposited (e.g., P3HT on TiO₂). On a per surface area basis, these hybrid photocatalysts are comparable or better than other best in class polymer semiconductor photocatalysts. VPI of TiCl₄+H₂O into P3HT makes a unique hybrid structure and idealized photocatalyst architecture by creating nanoscale TiOx clusters concentrated toward the surface achieving extremely high catalytic rates. The mechanism for this enhanced photocatalytic rate is understood using photoluminescence spectroscopy, which shows significant quenching of P3HT-TiOₓ as compared to neat P3HT, indicating that P3HT acts as a photosensitizer for the TiOₓ catalyst sites in the hybrid material. This work introduces a new approach to designing and synthesizing organic-inorganic hybrid photocatalytic materials, with expansive opportunities for further exploration and optimization.

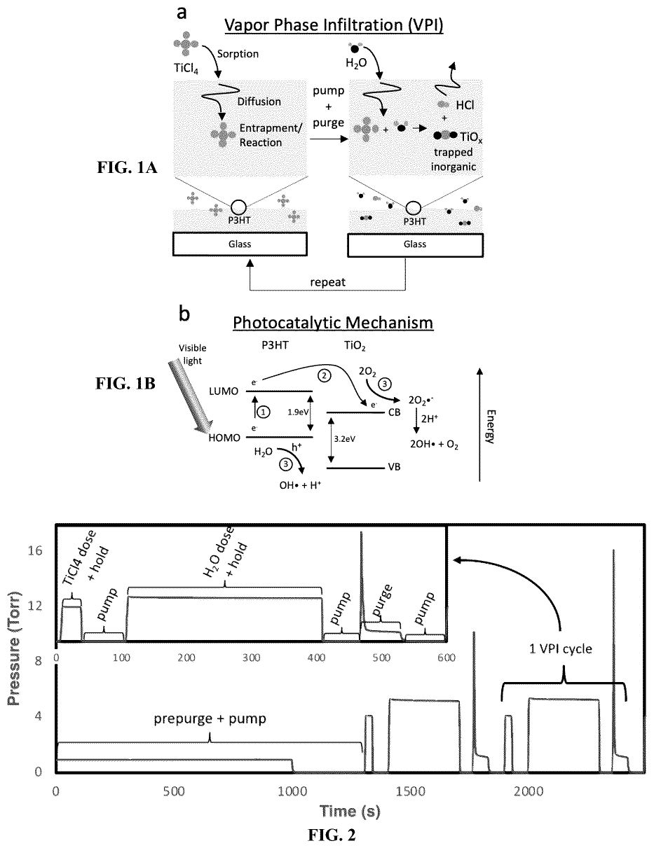

Traditional ALD processes dose gaseous precursors and coreactants into the reaction chamber separately. The precursor and coreactant independently and sequentially react with the substrate surface in a self-limiting fashion leading to an atomic-layer-by-atomic-layer deposition of a coating on the substrate's surface. As depicted in FIG. 1A, VPI uses similar gas-phase precursors and coreactants in a sequential dosing manner, but ideally these precursors are delivered without a carrier gas, and the system is isolated in a static atmosphere of just the precursor gas at a constant pressure for an extended time to permit the sorption and diffusion of these inorganic species into the polymer (Leng and Losego, “Vapor phase infiltration (VPI) for transforming polymers into organic-inorganic hybrid materials: a critical review of current progress and future challenges,” Mater. Horiz., 4(5):747-771 (2017); Leng and Losego, “A physiochemical processing kinetics model for the vapor phase infiltration of polymers: measuring the energetics of precursor-polymer sorption, diffusion, and reaction,” Phys. Chem., 2 (33):21506-21514 (2018)). The result of VPI, unlike ALD, is a modification of the bulk polymer chemistry, with the entrapment of inorganic clusters, often metal oxides (MOₓ) or hydroxides, inside the polymer. These inorganic clusters are seen as detrimental to the overall electronic conductivity of a doped CP because they act as scattering centers that reduce electronic mobility (Leng and Losego, “A physiochemical processing kinetics model for the vapor phase infiltration of polymers: measuring the energetics of precursor-polymer sorption, diffusion, and reaction,” Phys. Chem., 2(33):21506-21514 (2018); Malinowski et al., “Use of in situ electrical conductance measurements to understand the chemical mechanisms and chamber wall effects during vapor phase infiltration doping of poly(aniline) with TiCl4+H2O,” J. Vac. Sci. Technol., A, 40(1):013418 (2022); Pirkanniemi and Sillanpaa, “Heterogeneous water phase catalysis as an environmental application: a review,” Chemosphere, 48(10):1047-1060 (2002)). However, herein is demonstrated that these inorganic clusters can actually be utilized as sites for photocatalysis.

FIG. 1B depicts the expected photosensitization process for a P3HT-TiOₓ system. Visible light is absorbed by the CP, creating an exciton that consists of an excited electron and a hole. These photogenerated electrons are injected into the conduction band of TiOₓ, where they can then reduce O₂ in the presence of water to create reactive species such as OH radicals that serve as disinfectants that degrade a variety of organic compounds including dyes (Ajmal et al., “Principles and mechanisms of photocatalytic dye degradation on TiO2 based photocatalysts: a comparative overview. RSC Adv., 4(70):37003-37026 (2014). Essential to this photocatalytic process are (1) the photoexcitation of the CP to create an exciton and (2) the subsequent charge transfer of the photoexcited electron from the P3HT to the titania. The exciton diffusion length in P3HT has been reported to be between 3 and 8.5 nm (Kroeze et al, “Contactless Determination of the Photoconductivity Action Spectrum, Exciton Diffusion Length, and Charge Separation Efficiency in Polythiophene-Sensitized TiO2 Bilayers,” J. Phys. Chem. B, 107(31):7696-7705 (2003), Shaw et al., “Exciton Diffusion Measurements in Poly(3-hexylthiophene),” Adv. Mater., 20(18):3516-3520 (2008); Dugay et al., “Charge Mobility and Dynamics in Spin-Crossover Nanoparticles Studied by Time-Resolved Microwave Conductivity,” J. Phys. Chem. Lett., 9(19):5672-5678 (2018)), meaning that TiOₓ must be located no farther than 8.5 nm from where the exciton is generated for charge transfer to occur. A variety of synthesis methods have been employed to make CP-MOₓ composite photocatalysts (e.g., direct mixing of MOₓ and conjugate polymers (Lin et al., “Efficient Photocatalytic Degradation of Organic Pollutants by PANI-Modified TiO2 Composite,” J. Phys. Chem. C, 116(9):5764-5772 (2012); Zhang et al., “Photocorrosion Inhibition and Photoactivity Enhancement for Zinc Oxide via Hybridization with Monolayer Polyaniline,” J. Phys. Chem. C, 113(11):4605-4611 (2009)), coating conjugated polymers onto MOₓ (Kim et al., “Hollow cobalt ferrite-polyaniline nanofibers as magnetically separable visible-light photocatalyst for photodegradation of methyl orange,” J. Photochem. Photobiol., A, 321:257-265 (2016)), and coating MOₓ onto conjugated polymer (Yan et al., “Flexible Photocatalytic Composite Film of ZnO-Microrods/Polypyrrole,” ACS Appl. Mater. Interfaces, 9(34):29113-29119 (2017)), all showing the usefulness of this charge transfer to help photosensitize MOₓ for various applications (Zhang et al., “P3HT/Ag/TiO2 ternary photocatalyst with significantly enhanced activity under both visible light and ultraviolet irradiation. Appl. Surf. Sci., 488:228-236 (2019); Wu et al., “An ultraviolet responsive hybrid solar cell based on titania/poly(3-hexylthiophene),” Sci. Rep., 3(1):1283 (2013); Zhu and Dan, “Photocatalytic activity of poly(3-hexylthiophene)/titanium dioxide composites for degrading methyl orange,” Sol. Energy Mater. Sol. Cells, 94(10):1658-1664 (2010); Tran et al., “Advanced Photocatalysts Based on Conducting Polymer/Metal Oxide Composites for Environmental Applications,” Polymers, 13(18):3031 (2021)). Herein, inventors demonstrate VPI as a method for infiltrating the conjugated polymer P3HT with metal oxide clusters of TiOₓ and then demonstrate the utility of this hybrid material to photocatalyze the degradation of organic dyes.

An exemplary embodiment of the present disclosure provides a photocatalyst system. This system includes a photocatalyst comprising an organic material infused with clusters of an inorganic material diffused throughout a bulk of the organic material, wherein the organic material and the clusters of the inorganic material are configured such that the organic material photosensitizes the inorganic material.

In some embodiments, the photocatalyst is an organic-inorganic hybrid photocatalyst. In some embodiments, the photocatalyst is more photocatalytically active than either the organic material or inorganic material individually. In some embodiments, the photocatalyst further comprises a nanostructured surface.

In some embodiments, the system further comprises a light source. In some embodiments, the light source comprises visible light. The light source can be natural or artificial. In some embodiments, the light source is sunlight.

The organic material can comprise any organic compound that is able to photosensitize the inorganic material. As used herein, “photosensitize the inorganic material” means to increase the photocatalytic activity of the inorganic material in the presence of the light source.

In some embodiments the organic material comprises a conjugated, conducting polymer. In some embodiments, the conjugated, conducting polymer is poly(3-hexylthiophene-2,5-diyl) (P3HT).

In some embodiments, the organic material has a band gap of 1 eV to 3 eV. For example, in some embodiments, the organic material has a band gap of 1 eV to 1.5 eV, 1 eV to 2 eV, 1 eV to 2.5 eV, 1.5 eV to 2 eV, 1.5 eV to 2.5 eV, 1.5 eV to 3 eV, 2 eV to 2.5 eV, 2 eV to 3 eV, or 2.5 eV to 3 eV.

In some embodiments, the organic material is infused with the inorganic material via vapor phase infiltration process. In some embodiments, the inorganic material is at or near the surface of the organic material.

In some embodiments, the inorganic material comprises a metal oxide. Suitable metal oxides include, without limitation, titanium oxide, vanadium oxide, zinc oxide, tin oxide, cerium oxide, iron (III) oxide, chromium oxide.

Another exemplary embodiment of the present disclosure provides a method of photocatalyzing a reaction. This method includes providing any of the photocatalysts disclosed herein; mixing the photocatalyst with a reactant to form a reaction mixture; and exposing the reaction mixture to a light source.

Suitable photocatalysts are those of the present disclosure as described herein.

In some embodiments, the reactant is an organic compound. In some embodiments, the organic compound is a dye. In certain embodiments, the dye is methyl blue or methyl orange, but can be any dye, such as any of those used in the textile, paper and apparel industries.

In some embodiments, photocatalyzing a reaction comprises degrading a dye. Other reactions that can be photocatalyzed include, without limitation, oxidation of organic waste streams to CO₂, splitting H₂O to generate H₂, and photoelectric chemical synthesis.

In some embodiments, providing the photocatalyst comprises providing an organic material as described herein, providing an inorganic material as described herein, and dosing the organic material with the inorganic material via vapor phase infiltration.

It is to be understood that the embodiments and claims disclosed herein are not limited in their application to the details of construction and arrangement of the components set forth in the description and illustrated in the drawings. Rather, the description and the drawings provide examples of the embodiments envisioned. The embodiments and claims disclosed herein are further capable of other embodiments and of being practiced and carried out in various ways. Also, it is to be understood that the phraseology and terminology employed herein are for the purposes of description and should not be regarded as limiting the claims.

Accordingly, those skilled in the art will appreciate that the conception upon which the application and claims are based may be readily utilized as a basis for the design of other structures, methods, and systems for carrying out the several purposes of the embodiments and claims presented in this application. It is important, therefore, that the claims be regarded as including such equivalent constructions.

Furthermore, the purpose of the foregoing Abstract is to enable the United States Patent and Trademark Office and the public generally, and especially including the practitioners in the art who are not familiar with patent and legal terms or phraseology, to determine quickly from a cursory inspection the nature and essence of the technical disclosure of the application. The Abstract is neither intended to define the claims of the application, nor is it intended to be limiting to the scope of the claims in any way.

### EXAMPLES

The following Examples are presented to illustrate various aspects of the present application, but are not intended to limit the scope of the claimed application.

### Example 1—Materials and Methods

### Film Fabrication and Characterization

Solution Preparation and Spray Coating. Regioregular poly(3-hexylthiophene-2,5-diyl, P3HT, Sigma-Aldrich, molecular weight=50,000-100,000 g/mol) was dissolved in toluene (Sigma-Aldrich, purity=99.8%) at 10 mg/mL for thin film fabrication. P3HT films were prepared by spray casting 200 μL of this solution (heated to 50° C.) onto 7.5 cm×2.5 cm glass slides using a Master Airbrush G22 spray caster. Prior to casting, glass slides were cleaned with isopropyl alcohol and dried with N₂. After coating, glass slides were cut into approximately 2.5 cm×0.7 cm rectangles to fit the catalytic rate measurement setup. Films used for electrical conductivity measurements were cut into approximately 1 cm×1 cm squares. Film thicknesses were measured by scratching the film with a pair of tweezers and then using a Profilm 3D optical profilometer to measure the step edge.

### Vapor Phase Infiltration (VPI)

VPI was carried out in a custom-built pancake-style reactor using a vertically positioned 6-inch conflat tube (4-inch inner diameter) that is 4 inches in height. The total chamber volume was approximately 50 in³ (820 cm³). The top of the chamber has a standard conflat door for sample exchange. The chamber was operated at 80° C. for all reactions. A Leybold Trivac D16B with a pump speed of 19.8 m³/hr was used to evacuate the chamber. Both an activated charcoal and SodaSorb 9.5 inch VisiTrap® Inlet Trap were connected between the reactor chamber and pump in series and are the major sources of flow resistance. The reactor's valve sequencing was automatically controlled with LABVIEW software using a tree-architecture (Piercy and Losego, “Tree-based control software for multilevel sequencing in thin film deposition applications,” J. Vac. Sci. Technol. B, 33(4):043201 (2015).

Prior to reaction, thin films were inserted into the VPI reactor, and the chamber was pumped to its background pressure of 0.01 Torr and then purged with 99.995+% N₂ for 1000 s at a chamber pressure of 0.8 Torr. The VPI process was started by pumping down for 60 s to background pressure, isolating the chamber and then opening the valve to the room temperature TiCl4 precursor (Strem chemicals, 97% purity, DANGER: can generate corrosive HCl byproducts) for 1 s to achieve a chamber pressure of ˜4.5 Torr. The P3HT thin films were exposed to the TiCl4 precursor for 30 s in a static environment. After this exposure, the chamber was then evacuated down to background for 60 s. Deionized water was then dosed to a chamber pressure ˜5.5 Torr and held statically for 300 s. Between each VPI cycle, the chamber was evacuated for 30 s, purged with nitrogen to a chamber pressure of ˜0.8 Torr for 60 s, and evacuated down to the baseline for another 60 s. This precursor dose and hold, evacuation, water dose and hold, and vacuum, purge, and vacuum constituted a single reaction cycle, as shown in the inset of FIG. 2. The pressure profile of the entire VPI process for a 2 cycle VPI process is shown in FIG. 2. Note the 1000 s prepurge and 300 s evacuation to remove any adsorbed water/contaminants that may have entered the chamber when loading samples.

### Liquid Doping and Dedoping Procedures

For comparison, P3HT films were also liquid doped with solutions of 50 mM iron (III) p-toluenesulfonate hexahydrate (FeTos) in acetonitrile and 50 mM of nitrosonium hexafluorophosphate (NOPF₆) in acetonitrile. FeTos, NOPF₆, and acetonitrile (anhydrous, purity=99.8%) were purchased from Sigma Aldrich. The appropriate doping solution was drop cast onto the films. Films meant for electrical conductivity measurements received 50 μL, and films meant for catalytic measurements received 150 μL due to their larger surface area. Both were doped for 1 min followed by rinsing with excess acetonitrile to remove any excess dopant. Films were dried under a vacuum of ˜125 Torr for 10 min to ensure removal of solvent.

To dedope films, vapor-phase hydrazine exposure was used. Vapor dedoping was chosen to prevent film swelling and changes to crystallinity that occur from exposure to liquid solvents. Hydrazine (35 wt % in water) was purchased from Sigma-Aldrich and was diluted 1:100 using acetonitrile. 200 μL of the solution was transferred into a 20 mL scintillation vial with the film that was to be dedoped. The lid was closed, and the film was exposed to the hydrazine vapors for 30 min. After this hydrazine vapor exposure, the conductivity of the films was too low to be measured by an electrical resistance measurement tool.

### Methyl Blue Photodegradation Measurements

To measure photocatalytic activity, methyl blue (MB) degradation was tracked via its peak UV-Vis absorbance. Solutions of MB were made from 20 μL of MB dissolved in 2.5 mL of water. The temporal dependence of the absorbance was used to evaluate photocatalytic degradation kinetics. Prior to collecting rate data, films were pretreated by submersion in MB solution with the same concentration, as previously mentioned, for 1 hour in the dark to eliminate any possible non-photocatalytic reactions or adsorption processes that may occur between the film and MB solution. The film was then immediately placed into a new cuvette containing fresh MB solution for rate data collection.

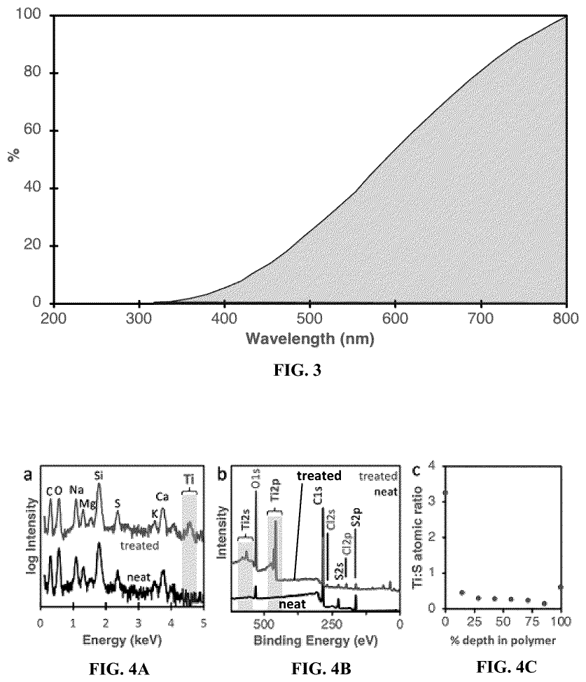

To determine the photocatalytic degradation rate, cuvettes containing 2.5 mL of MB solution and the catalyst film were exposed to an OSRAM HALOPAR 16 50 W 120V light (roughly 350 to 800 nm, light spectrum shown in FIG. 3) and mechanically agitated by attaching the cuvette holder to a vortex mixer. A separate broad spectrum light source was supplied via a fiber optic light source (the Ocean Insights DH-2000 light source with both a deuterium bulb and a halogen bulb). This light path travelled through the MB solution but did not intersect with the glass slide catalyst. This light beam was detected with a fiber optic spectrometer (Avantes Avaspec-ULS2048CL-EVO-RS detector) to track the optical absorbance of the MB solution over time. An absorbance spectrum was taken every 10 minutes for 3 hours. Despite the pretreatment, some reaction or adsorption behavior was still observed in many cases during the first 10-20 minutes of measurement. For this reason, this first 30 min was omitted when fitting into the rate law. Specifically, inventors found photodegradation to follow a first-order rate equation:

$$[ A ] = {[ A ]}_{0} {e}^{- kt} \qquad Eq . l$$

where t is time, [A]₀ is the initial concentration of MB, [A] is the concentration of MB at time t, and k is the chemical reaction rate constant. An example calculation showing the experimental methods and equations used to obtain the photocatalytic rate constant is provided below. Plots of peak UV-Vis absorbance with time were fit to this equation to extract part k. In order to correct for differences in the amount of catalyst, glass pieces were weighed and the effective catalyst area was approximated from the fractional weight of an uncut slide, nominally:

$$Surface area [ {cm}^{2} ] = mass of sample [ g ] * 19.3548 {cm}^{2} / 4.8569 g \qquad Eq . 2$$

The k-values were then normalized by dividing the k-value by the approximate catalyst surface area. To correct for variations in catalytic rate measurements, experiments were performed in triplicate, and the standard deviations are shown as the error bars in the results.

### Chemical Characterization and Property Measurement

X-ray Photoelectron Spectroscopy. X-ray photoelectron spectroscopy (XPS) was done using a Thermo Scientific K-alpha system with a monochromatic Al K_{α} X-ray source (1487 eV) having a 60° incident angle and 90° emission collection angle. High-resolution scans were collected at a step size of 0.1 eV. Adventitious carbon (248.8 eV) was used as the charge reference for the analysis. Measurements were taken within 24 hours of VPI processing to prevent any dedoping. Depth profiles were performed on the same instrument using a monatomic argon ion gun set at 1000 eV and a medium current for 90 s. At each level, survey scans and elemental analysis were performed.

Reflective Electron Energy Loss Spectroscopy (REELS). Reflective electron energy loss spectroscopy (REELS) was performed on a Thermo NEXSA G2 XPS system on samples that were not exposed to any X-rays. A pass energy of 10 eV and a step size of 0.1 eV were used. Four scans were collected for each sample.

UV-Vis spectroscopy. UV-Vis spectroscopy was used to characterize the optical absorption of the CP before and after infiltration and doping/dedoping. An Ocean Insights DH-2000 light source and an Avantes Avaspec-ULS2048CL-EVO-RS detector were used for this purpose.

Four-point probe. A Keithley 2400 source meter was used to measure the conductivity of films. A four-point probe head with spring loaded contacts was connected to the source meter. The sheet resistance was measured, and the electrical conductivity was calculated using the film thickness.

Energy Dispersive X-ray Spectroscopy. Elemental analysis was done on samples by using a Phenom ProX benchtop scanning electron microscope (SEM). Energy dispersive X-ray (EDX) spectra were obtained using point analysis while scanning at 15 kV in the backscatter mode for elemental Ti detection. EDX spectra were also obtained in a map analysis at 15 kV in the backscatter mode to show a uniform distribution of Ti throughout the film.

Scanning Electron Microscopy (SEM). High-magnification images of samples were obtained using a Hitachi SU8230 instrument at 10 kV in the secondary electron mode. A 16.6 mm working distance and a 500,000× magnification was used.

Fourier Transform Infrared (FTIR) Spectroscopy. Functional group analysis was done on samples using a Shimadzu IR Prestige-21 Fourier Transformed Infrared Spectrophotometer in an ATR configuration.

Photoluminescence Spectroscopy (PL). Analysis of excited electron orbital states was done using a Horiba FL3-21 Fluorometer with a sample angle of ˜30° from the detector. An excitation wavelength of 515 nm was used since it is close to the peak excitation wavelength of P3HT. To account for different optical absorbances between neat and treated P3HT, PL spectra were normalized according to

$$P {L}_{n o r malized} = P {L}_{r a w} / 1 - {T}_{excitation} \qquad Eq . 3$$

where PL_{normalized} and PL_{raw} are the photoluminescence of the sample after normalization and as collected, respectively, and T_{excitation} is the transmittance of the sample at the excitation wavelength (515 nm in this case).

Grazing Incidence Wide-Angle X-ray Scattering (GIWAXS). Molecular distance probing was performed at Brookhaven National Lab at the 12-ID Soft Matter Interfaces (SMI) beamline of the National Synchrotron Light Source II (NSLS-II). Polymer films were prepared by spray casting onto p-doped silicon wafers and then treated, as previously described. On each film, 3 measurements were taken at different positions, and the most representative within the series is reported here. A 0.1° angle of incidence was used for all measurements.

### Example 2—Results and Discussion

### Chemical and Electronic Structure of P3HT-TiOₓ Hybrid Films

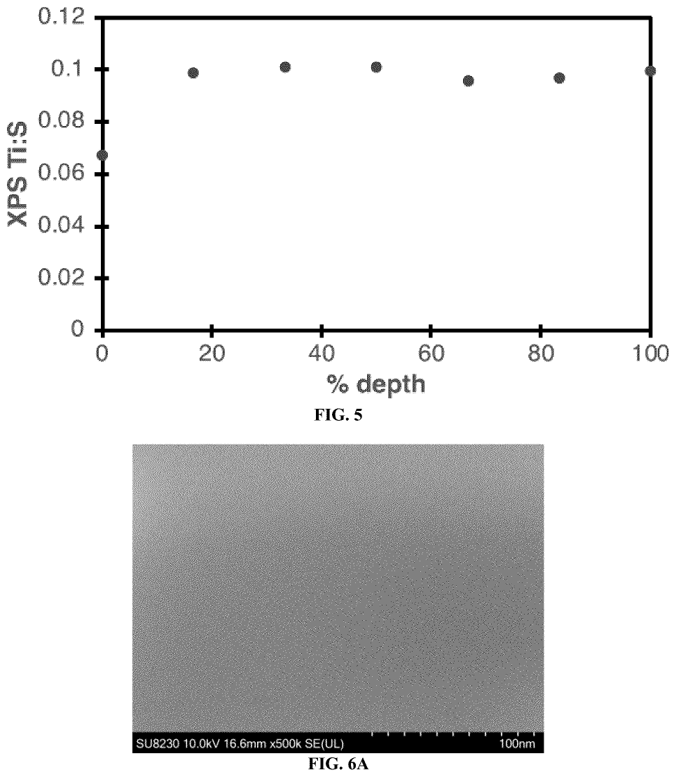

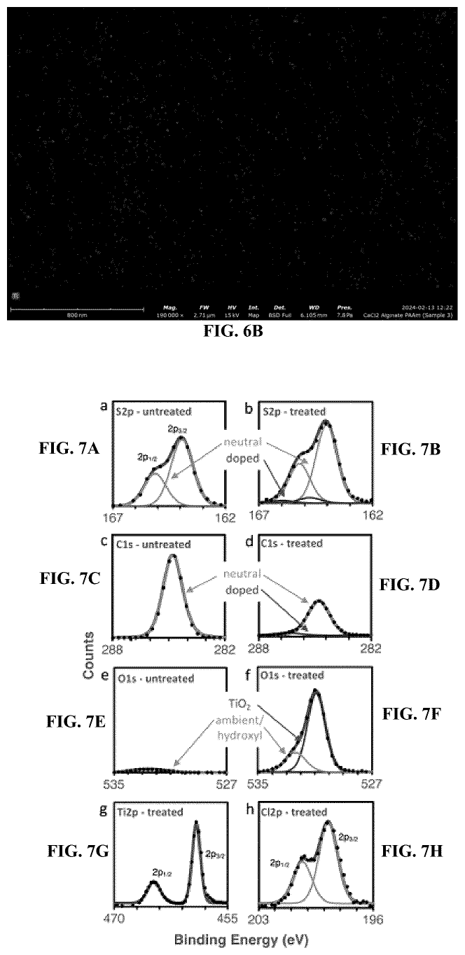

Vapor phase infiltration of P3HT with metal halides (e.g., MoCl₅ and FeCl₃) (Wang et al., “Efficient and controllable vapor to solid doping of the polythiophene P3HT by low temperature vapor phase infiltration,” J. Mater. Chem. C, 5(10):2686-2694 (2017); Yamamoto and Furukawa, “Electronic and Vibrational Spectra of Positive Polarons and Bipolarons in Regioregular Poly(3-hexylthiophene) Doped with Ferric Chloride,” J. Phys. Chem. B, 119(13):4788-4794 (2015)) has been previously reported in the scientific literature, but doping P3HT with TiCl₄ and H₂O has not been shown. To confirm that TiCl₄ and H₂O infiltrate into P3HT (and to what extent), this hybrid material was first characterized with EDX and XPS. FIGS. 4A-4B show both EDX spectra (FIG. 4A) and XPS survey spectra (FIG. 4B) for a ˜150 nm neat P3HT film and a ˜150 nm P3HT film infiltrated with TiOₓ at 80° C. for 5 cycles. In both FIGS. 4A and 4B, the C and S peaks are inherent to the polymer. In FIG. 4A, a clear Ti peak emerges at 4.5 keV in the treated sample that is not present in the neat polymer. Additionally, in FIG. 4B, the XPS survey scan further confirms the presence of Ti with both Ti 2p and Ti 2s peaks present. To quantify the degree of infiltration, an XPS depth profile plotting the Ti:S ratio in the treated polymer is shown in FIG. 4C. This depth profile shows a high concentration of Ti near the surface but a lower and somewhat constant concentration within the bulk (Ti:S atomic ratio≈0.3). Based on this Ti/S atomic ratio and reported exciton diffusion lengths, inventors predict that it is possible for every exciton generated by the P3HT to be quenched by the TiOₓ. For the exciton transfer from the P3HT to the TiOx, there must be a TiOx cluster available to absorb the excited electron before the exciton recombines. The average distance an exciton is able to travel before recombining is defined as the exciton diffusion length. The calculations to make this prediction are detailed below and in FIG. 5. Additionally, SEM images (FIG. 6A) show the inorganic clusters are extremely fine (likely <5 nm in size) and imperceptible by SEM. Additionally, EDX mapping (FIG. 6B) shows that the Ti is relatively uniformly distributed throughout the hybrid film. Further details and discussion on SEM images are included below.

Potential Exciton Diffusion Length and Quenching. For P3HT, the exciton diffusion length has been measured to be around ˜3 to 8.5 nm (˜7.5 to 21 monomers) (Lin et al., “Spontaneous dissociation of a conjugated molecule on the Si(100) surface,” The Journal of Chemical Physics, 117(1):321-330 (2002)). Using the XPS depth profiles, the distance between Ti clusters can be measured. As shown in FIG. 4C, the Ti:S ratio is ˜0.3, equating to a Ti for every 3 monomers, although this assumes a uniform distribution of Ti and no clustering, well within the reported exciton diffusion range. To reduce any potential inaccuracies due to clustering of the Ti in the polymer, which is quite likely given the multiple cycles treatment, depth profiles of a 1 cycle infiltration sample were taken (FIG. 5) and a Ti:S≈0.1 was found in the bulk of the polymer. This corresponds to a Ti for every 10 monomers, slightly higher than the lower limit of the exciton diffusion range. At these concentrations, the TiOx clusters theoretically should be sufficient to collect nearly every exciton generated by the P3HT.

Additional P3HT-TiOₓ Physical/Chemical Characterization. SEM image (FIG. 6A) shows that the inorganic clusters infiltrated during VPI cannot be seen in the hybrid material. EDX mapping (FIG. 6B) shows a homogenous distribution of Ti throughout the plane of the polymer film. The inability to image the infiltrated clusters is expected as this has been observed in previous publications as well (McGuinness et al., “Vapor Phase Infiltration of Metal Oxides into Nanoporous Polymers for Organic Solvent Separation Membranes,” Chemistry of Materials, 31(15):5509-5518 (2019)). Additionally, ALD studies have shown TiCl₄+H₂O deposition to result in ˜0.05 nm/cycle (Aarik et al., “Atomic layer deposition of titanium dioxide from TiCl4 and H2O: investigation of growth mechanism,” Applied Surface Science, 172(1):148-158 (2001)). This would equate to a theoretical max of 0.45 nm clusters, below the practical resolution of SEM imaging.

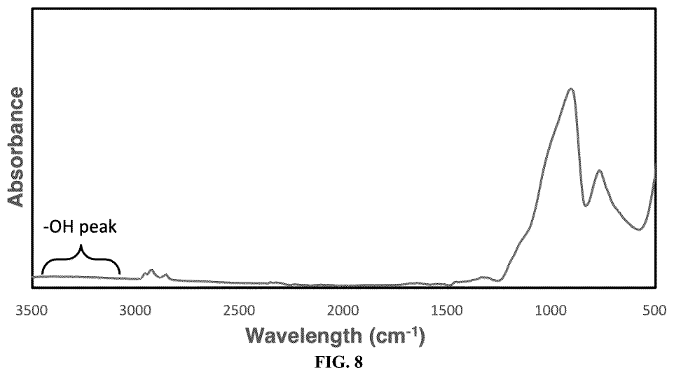

To better understand the P3HT-TiOₓ hybrid structure, high resolution XPS spectra are presented in FIGS. 7A-7H. The C 1s and S 2p spectra are used to characterize the polymer. The neat P3HT S 2p spectrum (FIG. 7A) fits well to a single doublet, but the VPI-treated material necessitates a second doublet at higher binding energies (˜0.8 eV higher) for a good fit (FIG. 7B). Similarly, the C 1s spectrum for the neat P3HT fits well to a single peak, while the VPI-treated P3HT requires a second peak at higher binding energies to maintain reasonable peak widths and fit (FIGS. 7C-7D). From the literature, it is known that as P3HT becomes doped, the generated polarons create delocalized positive charges that shift the S and C spectra toward higher binding energies (Shallcross et al., “Quantifying the Extent of Contact Doping at the Interface between High Work Function Electrical Contacts and Poly(3-hexylthiophene) (P3HT),” J. Phys. Chem. Lett., 6(8):1303-1309 (2015); Kolesov et al., “Solution-based electrical doping of semiconducting polymer films over a limited depth,” Nat. Mater., 16(4):474-480 (2017). Upon deconvolution, the additional peaks labeled as “doped” in the C 1s and S 2p spectra are consistent with peaks previously observed for polaronic species in doped P3HT. The low intensity of these peaks is consistent with the low amount of doping observed in these materials; the measured conductivity for the P3HT-TiOx hybrids is only 2.7×10⁻⁶ S/cm, well below the ˜10° to 10¹ S/cm values expected for a highly doped P3HT polymer (Gregory et al, “Quantifying charge carrier localization in chemically doped semiconducting polymers,” Nat. Mater., 20(10):1414-1421 (2021); Wu et al., “Anion-Dependent Molecular Doping and Charge Transport in Ferric Salt-Doped P3HT for Thermoelectric Application.” ACS Appl. Electron. Mater., 3(3):1252-1259 (2021)).

In FIGS. 7E-7H, the O 1s, Ti 2p and Cl 2p spectra are analyzed to understand the chemical structure of the inorganic. In the untreated P3HT (FIG. 7E), minimal oxygen is detected, as expected. After infiltration (FIG. 7F) a significant oxygen signal emerges, nominally from the infiltrated TiOₓ. This oxygen signal can be reasonably deconvoluted into two peaks, one large peak centered at 530.9 eV and a smaller peak at 532.4 eV. These peaks have full width at half maximum (fwhm) values of 1.56 and 1.46 eV respectively, consistent with expectations for O 1s emissions (Diebold and Madey, “TiO2 by XPS,” Surf. Sci. Spectra, 4(3):227-231 (1996)). The large peak centered at 530.9 e V is consistent with literature reports for metal oxide (M-O-M) chemical states, including TiO₂. The lower intensity peak at 532.4 eV is more difficult to properly assign. This emission energy is consistent with a variety of C—O bonds (Beamson, “High Resolution XPS of Organic Polymers: The Scienta ESCA300 Database (Beamson, G.; Briggs, D.), J. Chem. Educ., 70(1):A25 (1993)), and matches emissions observed for P3HT oxidized from ambient oxygen (Tai et al, “The Enhanced Formaldehyde-Sensing Properties of P3HT-ZnO Hybrid Thin Film OTFT Sensor and Further Insight into Its Stability,” Sensors, 15(1):2086-2103 (2015); Nurazzi et al., “The Influence of Reaction Time on Non-Covalent Functionalisation of P3HT/MWCNT Nanocomposites,” Polymers, 13(12):1916 (2021)). Additionally, some literature reports have found Ti—OH bonds to be near 532 eV with no noticeable changes to the Ti spectrum, but the general instability of titanium hydroxide make such reports infrequent and somewhat unreliable (Huang et al., “Nonstoichiometric Titanium Oxides via Pulsed Laser Ablation in Water,” Nanoscale Res. Lett. 5(6):972-985 (2010); Jin et al., “Removal of Pb(ii) by nano-titanium oxide investigated by batch, XPS and model techniques,” RSC Adv., 5(107):88520-88528 (2015)). To test for the presence of Ti—OH species, FTIR measurements of the hybrid films were performed, and these FTIR do not show any evidence of −OH vibrations as the FTIR spectrum does not have a broad hydroxyl peak around 3300 cm⁻¹ (FIG. 8). At this point, though, it is unclear if this evidence means that the titanium is not hydroxylated, or the concentration is so low that it is undetectable with FTIR.

Next, the Ti 2p (FIG. 7G) spectrum was interpreted. A single doublet is observed at energies of 459.2 and 465.38 eV, consistent with the values reported for emission from Ti⁴⁺ from the 2p_{3/2} and 2p_{1/2} states respectively (Zhu and Dan, “Photocatalytic activity of poly(3-hexylthiophene)/titanium dioxide composites for degrading methyl orange,” Sol. Energy Mater. Sol. Cells, 94(10):1658-1664 (2010); Diebold and Madey, “TiO2 by XPS,” Surf. Sci. Spectra, 4(3):227-231 (1996); Mayer et al., “Titanium and reduced titania overlayers on titanium dioxide(110),” J. Electron Spectrosc. Relat. Phenom., 73(1):1-11 (1995)). The Ti³⁺ oxidation state would have peaks centered at 456.3 eV and 460.5 eV respectively; these are clearly not present in the Ti 2p spectrum (FIG. 7G) (Sleigh et al., “On the determination of atomic charge via ESCA including application to organometallics,” J. Electron Spectrosc. Relat. Phenom., 77(1):41-57 (1996); Piercy et al., “Variation in the density, optical polarizabilities, and crystallinity of TiO2 thin films deposited via atomic layer deposition from 38 to 150° C. using the titanium tetrachloride-water reaction,” J. Vac. Sci. Technol., A, 35(3):03E107 (2017)). Thus, the Ti spectrum provides strong evidence that nearly all of the infiltrated Ti is in the 4⁺ oxidation state.

Next, the Cl 2p spectrum was examined (FIG. 7H). Here a typical Cl 2p doublet with the 2p_{3/2} emission at 198.7 eV and the 2p_{1/2} at 200.2 eV was observed. These values are within the range for an ionic Cl, which could belong to either a Cl⁻ ion charge balancing a polaron, a trapped H—Cl byproduct formed after reaction between water and TiCl₄, or an unreacted metal-chloride (Ti—Cl) bond (Gregory et al., “Vapor Phase Infiltration Doping of the Semiconducting Polymer Poly(aniline) with TiCl4+H2O: Mechanisms, Reaction Kinetics, and Electrical and Optical Properties,” ACS Appl. Polym. Mater., 3(2):720-729 (2021); Ntais and Siokou, “An XPS investigation of the interaction mechanism between AlEt3 and TiCl4 supported on sputtered native SiOx layer,” J. Mol. Catal. A: Chem., 245(1-2):87-92 (2006); Mousty-Desbuquoit et al. “Solid state effects in the electronic structure of TiCl4 studied by XPS,” J. Chem. Phys., 79(1):26-32 (1983)). Differentiating amongst these chemical states is difficult, and unfortunately, the Ti 2p emission for Ti—Cl bonds is nearly the same as that for Ti—O bonds (458.8 eV versus 458.7 eV for the 2p_{3/2} state) (Pilling et al., “Combined far infrared RAIRS and XPS studies of TiCl4 adsorption and reaction on Mg films,” Surf. Sci., 587(1-2):78-87 (2005); Sleigh et al., “On the determination of atomic charge via ESCA including application to organometallics,” J. Electron Spectrosc. Relat. Phenom., 77(1):41-57 (1996)). From the ALD literature, it is known that at low process temperatures (like those used here), a significant quantity of the TiCl₄ remain incompletely hydrolyzed, so some amount of TiOₓCl₄₋₂ₓ is possible (Piercy et al., “Variation in the density, optical polarizabilities, and crystallinity of TiO2 thin films deposited via atomic layer deposition from 38 to 150° C. using the titanium tetrachloride-water reaction,” J. Vac. Sci. Technol., A, 35(3):03E107 (2017)). Estimations of the O/Cl atomic percent are 19.5:1 meaning that, if any Ti—Cl exists, it is only at most 5% relative to Ti—O content.

Finally, inventors note that TiOₓS_{y} is another potential chemical state for the Ti. However, literature reports for Ti—S have its 2p_{3/2} binding energy near 458.7 eV when 1>x/y>0.2 and multiple 2p_{3/2} peaks are usually observed (Gonbeau et al., “XPS study of thin films of titanium oxysulfides,” Surf. Sci., 254(1-3):81-89 (1991)). Although the binding energy is within range for what was measured, there is only one peak in the Ti 2p spectrum, and the expected Ti—S bond at around 161 eV in the S 2p spectra is not present (Gonbeau et al., “XPS study of thin films of titanium oxysulfides,” Surf. Sci., 254(1-3):81-89 (1991); Fleet et al., “Polarized Xray absorption spectroscopy and XPS of TiS3: S K- and Ti L-edge XANES and S and Ti 2p XPS,” Surf. Sci., 584(2-3):133-145 (2005)). Thus, with the available data, it is reasonable to conclude that no significant amount of Ti—S bonds are forming.

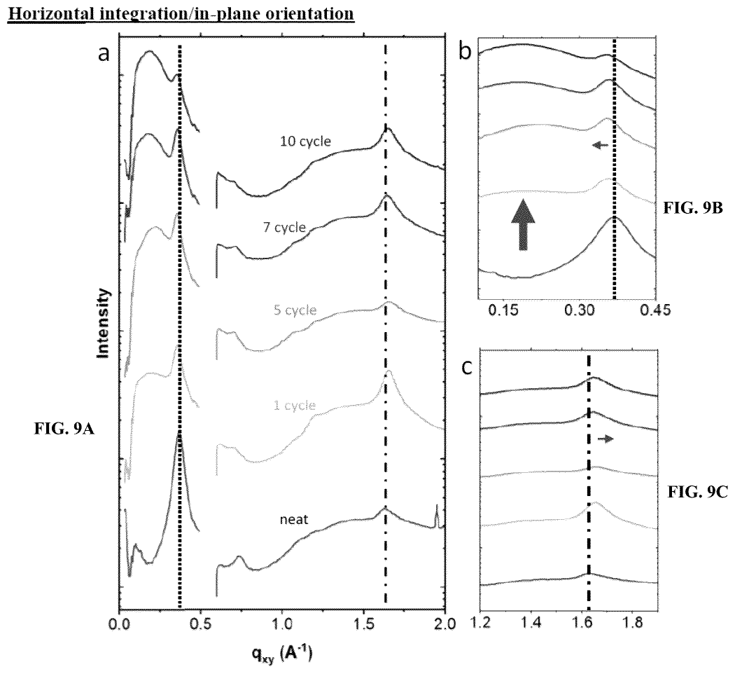

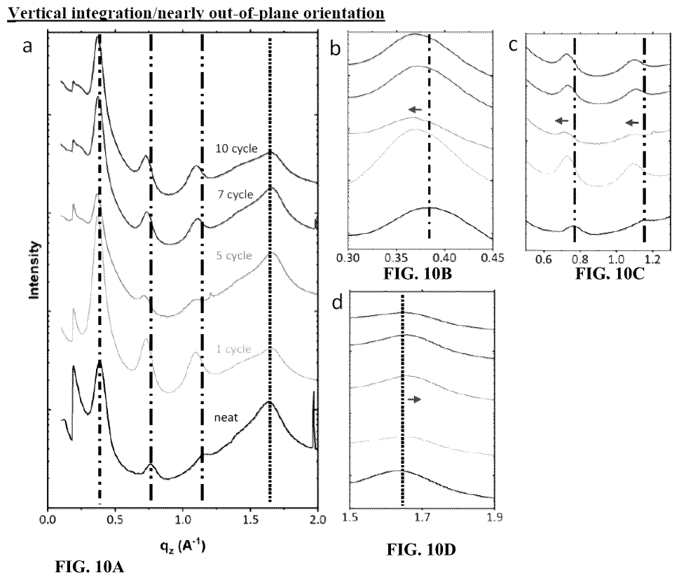

To investigate the nanoscale structure and impact on P3HT by the TiOₓ clusters made via VPI, grazing incidence wide-angle X-ray scattering (GIWAXS) measurements were performed (FIGS. 9A-9C, 10A-10D, 11A-11E) showing that the d-spacing between alkyl side chains increases (q-spacing decreases), while the d-spacing between π-π stacks decreases (q-spacing increases) for the infiltrated samples as compared to the neat. These structural changes indicate that as the TiCl₄ diffuses through the sample it does not disrupt much of the π-π stacking of the P3HT likely because the densely packed rigid backbone with strong π-π intermolecular forces leads to poor diffusion. On the other hand, the higher free volume and more mobile alkyl side chains likely lead to increased diffusion through the lamellar space, leading the resultant TiOₓ clusters to entrap themselves amongst the alkyl side chains. The same trends in structural changes have been observed for liquid doping of P3HT with Fe dopants, and the most common conclusion drawn from the GIWAXS data is that the counterions used in the dopant intercalate in between the alkyl chains and not the π-π stacks. The conclusions made in these other studies and the GIWAXS data measured herein indicate that TiCl₄ primarily diffuses through the alkyl chains. Such changes are expected whenever doping occurs in CP, such as P3HT (Al Kurdi et al., “Iron(III) Dopant Counterions Affect the Charge-Transport Properties of Poly(Thiophene) and Poly-(Dialkoxythiophene) Derivatives,” ACS Appl. Mater. Interfaces, 14(25):29039-29051 (2022); Lim et al., “Thermoelectric Properties of Poly(3-hexylthiophene) (P3HT) Doped with 2,3,5,6-Tetrafluoro-7,7,8,8-tetracyanoquinodimethane (F4TCNQ) by Vapor-Phase Infiltration,” Chem. Mater., 30(3):998-1010 (2018)). In addition to changes in the polymer structure, a new broad peak near 0.2 Å⁻¹ is observed in all the treated samples. This peak increases with VPI cycle count and inorganic abundance and is not present in the neat polymer. The low q-spacing (high d-spacing) of this peak is indicative of relatively large features. The combination of the emergence of the peak for all treated samples and the low q-spacing leads to the conclusion that this scattering event emerges from the TiOₓ nanoclusters.

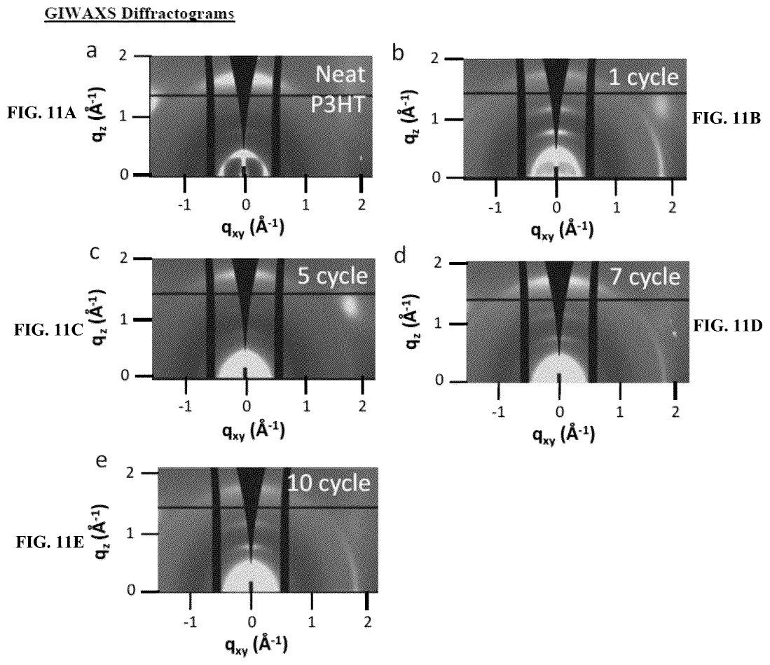

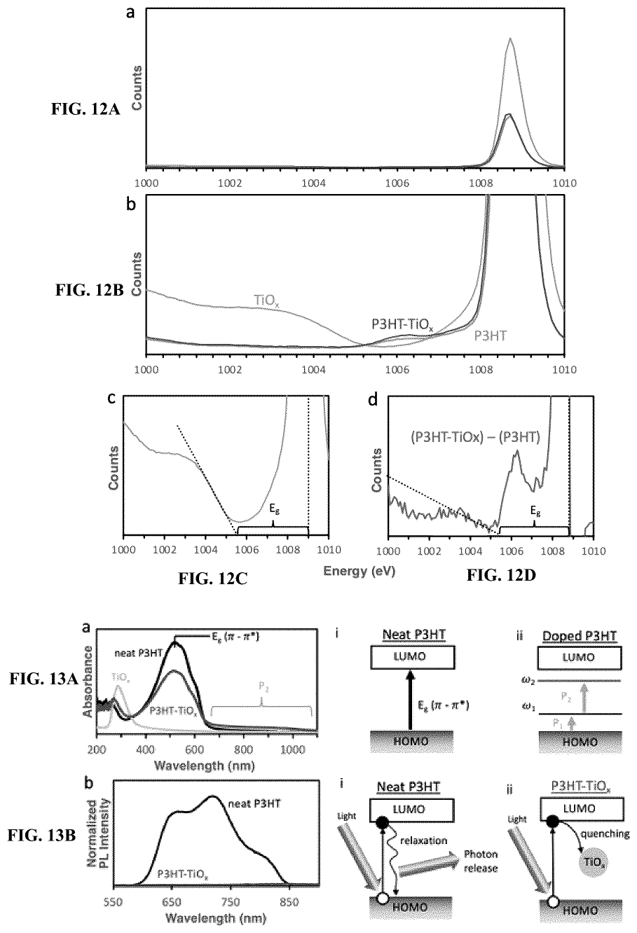

Additionally, VPI seems to have an effect on the crystalline orientation of the P3HT polymer. This can be seen in FIGS. 11A-11E as the band at qz=1.8 Å⁻¹ seems to become more in-plane (ring-like) and less out-of-plane. This is indicative of the polymer changing from face-on to a mix of face-on and edge-on orientation (Aubry et al., “Processing Methods for Obtaining a Face-On Crystalline Domain Orientation in Conjugated Polymer-Based Photovoltaics,” The Journal of Physical Chemistry C, 122(27):15078-15089 (2018). FIGS. 12A-12D show the REELS spectra used to determine the bandgap of the inorganic TiOₓ in both its pure form and the clusters within the P3HT-TiOₓ hybrid material. The bandgap is the difference between the incident beam (1008.7 eV) and the x-intercept of a linear line through the elastically scattered portion of curve. To obtain the bandgap of the TiOₓ in the hybrid, the neat P3HT curve was subtracted from the P3HT-TiOₓ hybrid curve, as shown in FIG. 12D. The bandgap for pure TiOₓ was found to be 3.17 eV and for that in the hybrid it was 3.05 eV, though there is considerably more error in the hybrid because of its relatively low fraction of Ti. The similar band gaps give an indication that there is minimal electron orbital interaction between the infiltrated inorganic and organic in the ground state. Furthermore, since it is generally established that low temperature (<150° C.) ALD deposition of TiO₂ from TiCl₄ and H₂O results in amorphous films (Niemelä et al., “Titanium dioxide thin films by atomic layer deposition: a review,” Semiconductor Science and Technology, 32(9):093005 (2017); Piercy et al., “Variation in the density, optical polarizabilities, and crystallinity of TiO2 thin films deposited via atomic layer deposition from 38 to 150° C. using the titanium tetrachloride-water reaction,” Journal of Vacuum Science & Technology A, 35(3):03E107 (2017)) and the infiltrated inorganics show a similar band gap to an amorphous TiO₂, inventors believe the infiltrated inorganics are amorphous in structure. Due to the small length scale of the infiltrated inorganics, as shown in FIGS. 6A-6B, there is minimal long-range order in their structure. This makes direct probing of the crystalline state extremely difficult. However, based on the evidence presented and knowledge of vapor deposition techniques, it is reasonable to conclude that the infiltrated inorganics are amorphous.

To better understand the electronic structure of these hybrid materials, UV-Vis-NIR and Photoluminescence (PL) spectroscopies were used. FIG. 13A plots the UV-vis absorbance spectra for a 150 nm, undoped P3HT film on glass before (neat) and after 5 cycles of infiltration (P3HT-TiOₓ) as well as an ALD deposited TiO₂ film on glass as reference. FIG. 13A(i, ii) depicts the expected band structures for the undoped and doped P3HT materials. As expected, the pure P3HT absorbs in the visible region (λₘₐₓ=517.7 nm), attributed to the π→π* transition (shown in FIG. 13A(i), with near-zero absorbance at wavelengths >650 nm (Farouil et al., “Revisiting the Vibrational and Optical Properties of P3HT: A Combined Experimental and Theoretical Study,” J. Phys. Chem. A, 122(32):6532-6545 (2018); Deibel et al., “Energetics of excited states in the conjugated polymer poly(3-hexylthiophene),” Phys. Rev. B: Condens. Matter Mater. Phys., 81(8):085202 (2010)). In contrast, the P3HT-TiOₓ hybrid has a decreased π→π* peak absorbance but higher overall absorbance at longer wavelengths (>650 nm). The reduced π→π* absorbance is indicative of additional states for excitation (e.g., the P1 and P2 transitions indicated in FIG. 13A(ii)), reducing the probability for full bandgap excitations (M. E et al., “Evidence of Polarons and Bipolarons in a Chemically Pressurized BiAlErCCeOy: A Monte-Carlo ion Bombardment Approach,” J. Phys.: Conf. Ser., 1622(1):012104 (2020)). Similarly, the increased absorbance in the red and near-IR is indicative of a polaronic absorbance in a doped P3HT material and is labeled as the P₂ transition in FIG. 13A(ii) (Enengl et al., “Doping-Induced Absorption Bands in P3HT: Polarons and Bipolarons,” ChemPhysChem, 17(23):3836-3844 (2016)). This emergence of a polaron absorbance is consistent with TiCl4 oxidatively doping the bulk of the polymer and provides further evidence that an infiltration has occurred. At shorter wavelengths, a strong absorbance emerges in the P3HT-TiOₓ hybrid near 290 nm, similar to the absorbance at 300 nm observed in the TiOₓ ALD film. Literature reports have found that when TiOₓ is mixed with P3HT, the hybrid material will have increased UV absorbance due to the TiOₓ absorbance (Kroeze et al., “Contactless Determination of the Photoconductivity Action Spectrum, Exciton Diffusion Length, and Charge Separation Efficiency in Polythiophene-Sensitized TiO2 Bilayers,” J. Phys. Chem. B, 107(31):7696-7705 (2003); Foe et al., “Stability of High Band Gap P3HT: PCBM Organic Solar Cells Using TiOx Interfacial Layer,” Int. J. Photoenergy, 2014:784724 (2014)). The lack of any new absorbance peaks (with exception to the expected polaronic peak due to doping) indicates minimal interactions of electronic bands between P3HT and TiOₓ in the ground state. REELS measurements performed on the pure and hybrid materials also suggest that the infiltrated TiOₓ clusters maintain a bandgap of about 3.17 eV as expected for amorphous TiO₂, although the accuracy of this measurement is limited by the low fraction of inorganic in this material (see FIGS. 12A-12D). FIGS. 12A-12B shows the REELS spectra used to determine the bandgap of the inorganic TiOₓ in both its pure form and the clusters within the P3HT-TiOₓ hybrid material. The bandgap is the difference between the incident beam (1008.7 eV) and the x-intercept of a linear line through the elastically scattered portion of curve. To obtain the bandgap of the TiOx in the hybrid, the neat P3HT curve was subtracted from the P3HT-TiOₓ hybrid curve, as shown in FIGS. 12C-12D. The bandgap for pure TiOx was found to be 3.17 eV and for that in the hybrid it was 3.05 eV, though there is considerably more error in the hybrid because of its relatively low fraction of Ti. The similar band gaps give us indication that there is minimal electron orbital interaction between the infiltrated inorganic and organic in the ground state. Furthermore, since it is generally established that low temperature (<150° C.) ALD deposition of TiO₂ from TiCl₄ and H₂O results in amorphous films (Niemelä et al., “Titanium dioxide thin films by atomic layer deposition: a review,” Semiconductor Science and Technology, 32(9):093005 (2017) and the infiltrated inorganics show a similar band gap to an amorphous TiO₂, inventors believe the infiltrated inorganics are amorphous in structure. Due to the small length scale of the infiltrated inorganics, as shown in FIGS. 6A-6B, there is minimal long-range order in their structure. This makes direct probing of the crystalline state extremely difficult. However, based on the evidence presented and knowledge of vapor deposition techniques, inventors believe it is reasonable to conclude that the infiltrated inorganics are amorphous.

To evaluate changes in the electronic band structure in the excited state, photoluminescent (PL) spectra are reported in FIG. 13B. These spectra are normalized to the transmittance at the excitation wavelength (515 nm). As depicted in FIG. 13B(i), photoexcited electrons in P3HT are expected to decay with the release of a photon in PL, giving the emission spectrum observed in FIG. 13B. If these photoexcited electrons are successfully injected into the infiltrated TiOₓ clusters in the hybrid material, then this photoemission should be quenched, as depicted in FIG. 13B(ii). Indeed, as shown in FIG. 13B, the PL spectrum for the P3HT-TiOₓ hybrid exhibits a 2 to 3 orders of magnitude decrease in PL intensity. If there were orbital mixing in the ground (non-excited) state, new peaks would be expected in the UV-Vis spectra. The only new peaks in the UV-Vis spectra are the polaronic peak and the metal oxide absorption. These absorptions are due to changes in the P3HT electronic structure and existence of the metal oxide, respectively. Therefore, the TiOₓ and P3HT orbitals do not interact in the ground state. This narrows down the type of quenching to either collisional quenching or resonance energy transfer (RET). Isolating the exact mechanism is difficult. The primary difference is that collisional quenching requires a much smaller distance (a few angstroms) between quencher and fluorophore than RET (Jin et al., “Removal of Pb(ii) by nano-titanium oxide investigated by batch, XPS and model techniques,” RSC Advances, 5(107):88520-88528 (2015)). However, the exciton diffusion length, which helps determine collisional quenching, is much larger for P3HT than the molecules these models were developed to explain. Regardless of the exact quenching process, this reduction in PL intensity strongly suggests that the photoexcited electrons in the P3HT are being injected into TiOₓ and will be available for photocatalysis as proposed in FIG. 1B (Shaw et al., “Exciton Diffusion Measurements in Poly(3-hexylthiophene),” Adv. Mater., 20(18):3516-3520 (2008); Sariciftci et al., “Photoinduced Electron Transfer from a Conducting Polymer to Buckminsterfullerene,” Science, 258(5087):1474-1476 (1992); Mehta et al., “Capping ligand effect on charge transfer mechanism of hybrid organic-(P3HT):inorganic (PbSe) nanocomposites,” 2012 12th IEEE International Conference on Nanotechnology (IEEE-NANO), pp 1-5 (2012); Kumar, R.; Ansari, M. O.; Parveen, N.; Oves, M.; Barakat, M. A.; Alshahri, A.; Khan, M. Y.; Cho, “Facile route to a conducting ternary polyaniline@TiO2/GN nanocomposite for environmentally benign applications: photocatalytic degradation of pollutants and biological activity,” RSC Adv., 6(112):111308-111317 (2016)).

### Photocatalytic Performance

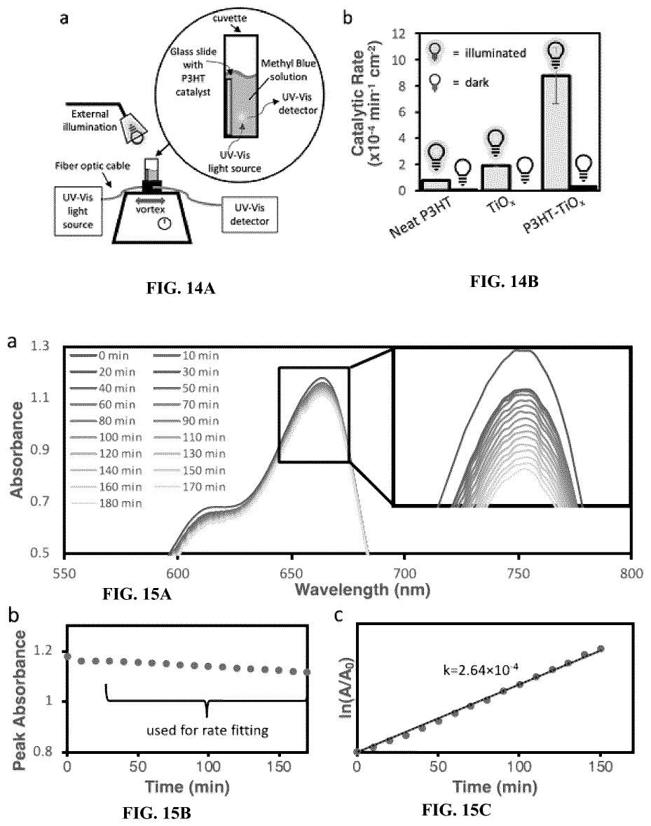

FIG. 14A depicts the experimental setup used to measure photocatalytic activity and the two light sources used to make measurements. Notably, one light source is used to measure the absorbance of the MB solution and does not interact with the thin film photocatalyst, while the other light source is a broad band light (350 to 800 nm) specifically used to photoactivate the thin film photocatalyst. Prior to any measurement for the photocatalytic rate, samples were submerged in MB solution under dark conditions for 1 hour to allow for any noncatalytic processes (reaction with HCl byproduct, adsorption, etc.) to occur.

Here is provided an example of how photocatalytic rate was calculated. This example data is collected from a pure TiO₂ ALD-deposited film on glass. Here, the film is exposed to broad band light while submerged in a solution of 0.0004 wt % MB, as depicted in FIG. 14A. FIG. 15A plots a series of absorbance spectra taken from the MB solution at varying times under constant illumination. FIG. 15B plots the peak absorbance from these UV-Vis spectra as a function of time. FIG. 15C plots the natural log of these absorbances normalized to the initial absorbance (after 30 min) versus time to linearize the data according to a first-order rate law equation:

$$ln ( {A}_{t} / {A}_{0} ) = k * t [ min ] \qquad Eq . 4$$

where Aₜ=absorbance at time t, A₀=initial absorbance (after 30 mins), k=rate constant and t=time in minutes. The slope of this linear fit is equal to the rate constant for this photocatalytic degradation reaction. Finally, to normalize for any slight variations in sample size, the slide was weighed and correlated to the surface area using equation 2, where the polymer was assumed to contribute a negligible amount of mass.

FIG. 14B plots the area-normalized rate constants for photocatalytic degradation of MB measured for neat (undoped) P3HT, ALD-deposited TiO₂, and VPI-synthesized P3HT-TiOₓ films under illuminated and dark conditions. All materials show more photocatalytic activity when illuminated than in the dark. Compared to the controls shown here, the P3HT-TiOₓ has significantly higher photocatalytic reactivity, about 11× higher than neat P3HT and 4.6× higher than pure TiO₂. This result confirms that the hybrid exhibits a light-activated synergistic photocatalytic effect between P3HT and TiOₓ that exceeds the photocatalytic performance of either component individually. Illumination is clearly necessary to activate this response, as the catalytic degradation rate for the P3HT-TiOₓ hybrid in the dark is near zero, while once illuminated, it exceeds 8×10⁻⁴ min⁻¹ cm⁻². This necessity for light and the combination of both P3HT and TiOₓ components provide evidence that this is a synergistic phenomenon, with P3HT likely acting as a sensitizer for TiOₓ, consistent with the mechanism of FIG. 1B and PL measurements from FIG. 13B.

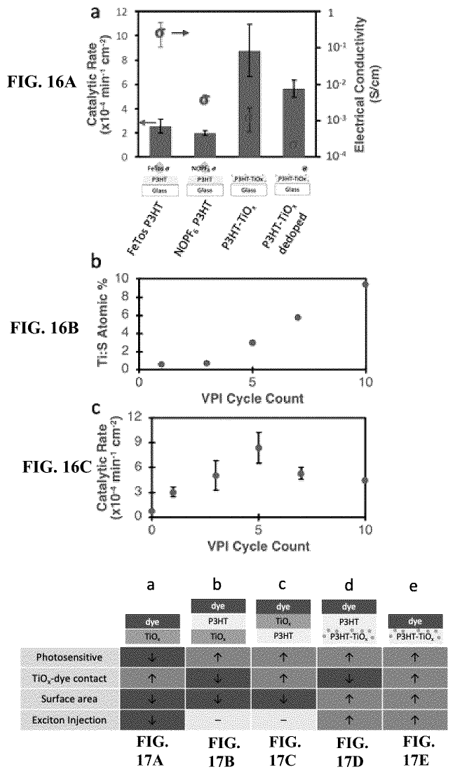

Notably, this TiCl₄ VPI process also dopes/oxidizes P3HT and increases the electrical conductivity, which is not a mechanism present in other physically blended CP-MOx composites. To understand the effects of semiconducting polymer doping and electrical conductivity on photocatalytic activity, a series of control systems are investigated. FIG. 16A shows both the electrical conductivities of these films (dots, right axis) and the photocatalytic reaction rates (bars, left axis). Specifically, the following systems were tested: (1) P3HT liquid doped with FeTos (contains Fe inorganic), (2) P3HT liquid doped with NOPF₆ (contains no metals), (3) VPI synthesized P3HT-TiOₓ hybrids (same hybrid data as in FIG. 14B), and (4) VPI synthesized P3HT-TiOₓ that has been dedoped with hydrazine vapor. As shown in FIG. 16A, the FeTos and NOPF₆ films, are significantly more electrically conductive than the P3HT-TiOₓ hybrids (5× to 100× more conductive). While these liquid-doped systems exhibit higher photocatalytic reaction rates than undoped P3HT, they are still 3-5× lower in photocatalytic activity than the P3HT-TiOₓ hybrid. While dedoping of the hybrid does lower its photocatalytic activity, these dedoped P3HT-TiOₓ films remain more photocatalytically active than either FeTos or NOPF₆-doped pure CP. These results agree with Xu et al., who reported an optimal oxidation of P3HT to achieve the highest photocatalytic activity in P3HT-metal oxide nanocomposites (Xu et al., “The influence of the oxidation degree of poly(3-hexylthiophene) on the photocatalytic activity of poly(3-hexylthiophene)/TiO2 composites,” Sol. Energy Mater. Sol. Cells, 96:286-291 (2012). Ultimately, these results suggest that the presence of the inorganic TiOₓ, not doping or electrical conductivity alone, is the primary driver for enhanced photocatalytic activity in this system.

Note that the XPS depth profiles (FIGS. 4C and 5) indicate that the infiltrated inorganic is more concentrated near the surface of the hybrid film, and thus, it is likely that the film's electrical conductivity varies with depth. Thus, the conductivity values reported in FIG. 16A are likely an “average” conductivity for the hybrid films. However, the multiple orders of magnitude differences between the P3HT-TiOₓ hybrid films and the liquid-doped films still provide strong evidence that the observed changes are not driven by conductivity alone but rather by the synergistic presence of the inorganic.

Prior synthesis methods of CP-MOₓ photocatalysts have also shown that the amount of MOₓ affects the photocatalytic activity (Zhang et al., “P3HT/Ag/TiO2 ternary photocatalyst with significantly enhanced activity under both visible light and ultraviolet irradiation,” Appl. Surf. Sci., 488:228-236 (2019); Zhang et al., “Dramatic Visible Photocatalytic Degradation Performances Due to Synergetic Effect of TiO2 with PANI,” Environ. Sci. Technol., 42(10):3803-3807 (2008)). In order to study this effect, a series of P3HT-TiOₓ hybrids were prepared in increasing numbers of VPI cycles. FIG. 16B plots the Ti/S ratio measured via XPS for each of these conditions. This data demonstrates that Ti concentration (at least at the near surface) increases with the number of cycles. FIG. 16C plots the corresponding photocatalytic degradation rates as a function of the number of VPI cycles. Here, the photocatalytic degradation rate peaks at 5 VPI cycles, which equates to a Ti/S surface ratio of 3. This result indicates that the photocatalytic activity does not continue to increase with increasing inorganic concentrations. Inventors postulate two possible explanations for this behavior. First, it was speculated that the charge transport between the P3HT and surface TiO₂ may be hindered as the TiOₓ volume increases, limiting injection efficiency. Second, as more cycles are applied, the clusters may begin to coalesce into a more continuous film that effectively decreases the effective surface area of the TiOₓ catalyst. However, more studies are needed to fully understand this phenomenon.

### Catalyst Architecture Considerations

The four key factors that have been identified for a high-performing CP-MOx are the (1) photosensitivity, (2) metal-oxide-to-dye contact, (3) metal oxide surface area, and (4) the ability to inject excitons generated in P3HT into the metal oxide. The (4) exciton injection and (2) the need for metal-oxide-to-dye contact are particularly important to consider when designing the photocatalyst architecture. When the CP is illuminated and excitons are generated, only excitons generated “close enough” to the MOₓ species will get injected into the inorganic catalyst. Therefore, only the MOₓ clusters in direct contact with or near the CP are actually photosensitized. Furthermore, these metal oxide clusters must be near or at the chemical interface with the species intended for degradation (e.g., liquid dye solution). If the CP-MOₓ photocatalysts are designed so that the CP is covering the MOₓ there will be significant hinderance to the catalytic ability because the dye first needs to diffuse through the CP layer before it can reach the MOₓ to be degraded. In other words, CP-MOₓ photocatalysts should be designed so that the MOₓ is near the surface.

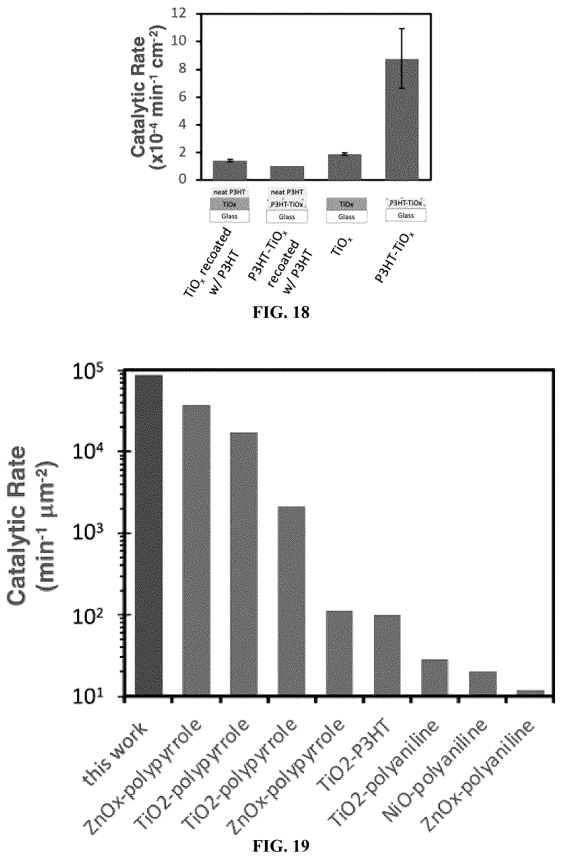

FIGS. 17A-17E present a variety of architectures for CP-MOₓ photocatalysts and provides qualitative assessments for each design's effectiveness in achieving each of the critical design parameters. The P3HT-TiOₓ architecture (FIG. 17E) is the main one described herein. However, inventors have made test structures mimicking each of the other architectures to confirm their effects on limiting performance. The results for these un-optimized designs are presented in FIG. 18. As can be seen, by adding a layer of CP onto either the TiOₓ or the VPI synthesized P3HT-TiOₓ, there is a significant reduction in the photocatalytic rate even below that of just TiOₓ.

With these key factors in mind, VPI is an excellent candidate for creating CP-MOₓ photocatalysts. Having both a CP and MOₓ means it is photosensitive. The MOₓ is in good contact with the dye since the MOₓ is concentrated towards the surface. The MOₓ has a higher surface area because it forms small atomic clusters, as opposed to a smooth film. Finally, the atomic clusters mean a significant amount of MOₓ atoms are in contact with the CP and are photosensitive.

### Comparison to Prior Reports

To better contextualize the results presented herein, the VPI P3HT-TiOₓ hybrid catalysts were compared to other CP-MOₓ photocatalysts reported in the literature. This comparison is presented in FIG. 19 with Table 1, which includes some notes about calculations made and references for each data point. Note that accurately normalizing catalytic rates is difficult given the variation in experimental methods used (e.g., catalyst loading, concentration of MB, light intensity, etc.), but this table provides reasonable insights into how the VPI P3HT-TiOₓ catalyst generally compares after normalizing to reported catalyst surface area. Inventor's best performing photocatalyst has a reaction rate constant of 8.7×10⁻⁴, which is comparable to the highest performing CP-MOₓ photocatalysts reported in the literature.

TABLE 1
Comparison of other Conjugated Polymer-Metal Oxide Photocatalysts
used for dye degradation from literature.

| | Surface Area Normalized | |
|---|---|---|
| Catalyst Materials/Design | k-value (min⁻¹ cm⁻²) | Notes |
| This work | 8.7 × 10⁻⁴ | |
| Polypyrrole grown onto ZnOₓ | 3.72 × 10⁻⁴ | # of microrods/surface area of film |
| Microrods¹ | | was estimated at 20/100 um² based |
| | | on SEM images |
| Nanostructured TiO₂- | 1.69 × 10⁻⁴ | Synthesized polypyrrole on |
| polypyrrole composites² | | uncoordinated Ti sites leading to |
| | | mostly monomer, dimer and |
| | | trimer, meaning the polymer film |
| | | is very thin. Diameter of |
| | | composites was taken as the |
| | | 250 nm diameter of the polypyrrole |
| | | granules, since they are much |
| | | larger than the TiO₂ nanoparticles |
| | | being used. |
| Polypyrrole grown onto TiO₂ | 2.09 × 10⁻⁵ | Methyl Orange was used instead of |
| nanoparticles³ | | Methyl Blue but comparison was |
| | | still made because TiO₂ were also |
| | | used. |
| ZnOₓ nanoparticles- | 1.12 × 10⁻⁶ | Surface area of composite not |
| polypyrrole composite⁴ | | directly reported but reference [5] |
| | | reports r = ~175 nm so this was used |
| | | in calculations. |
| TiO₂ particles with Ag | 1. × 10⁻⁶ | Methyl Orange was used instead of |
| nanoparticles solution coated | | Methyl Blue but comparison was |
| with P3HT⁶ | | still made because P3HT and TiO₂ |
| | | were also used. |
| TiO₂ nanoparticles solution | 2.84 × 10⁻⁷ | |
| coated with polyaniline⁷ | | |
| NiO particles synthesized in | 2.04 × 10⁻⁷ | Ni:monomer = ~1.54 mole ratio |
| situ with polyaniline⁸ | | |
| ZnOₓ nanoparticles solution | 1.18 × 10⁻⁷ | |
| coated with Polyaniline⁹ | | |

Note:
many studies were excluded from this comparison if the surface area for the catalyst could not be easily/confidently calculated.
References for Table 1:
¹Yan et al., “Flexible Photocatalytic Composite Film of ZnO-Microrods/Polypyrrole,” ACS Applied Materials & Interfaces, 9(34): 29113-29119 (2017).
²Dimitrijevic et al., “Nanostructured TiO2/Polypyrrole for Visible Light Photocatalysis,” The Journal of Physical Chemistry C, 117(30): 15540-15544 (2013).
³Li et al., “Preparation and characterization of polypyrrole/TiO2 nanocomposite and its photocatalytic activity under visible light irradiation,” Journal of Materials Research, 24(8): 2547-2554 (2009).

(4) Ovando-Medina et al., “Composite of acicular rod-like ZnO nanoparticles and semiconducting polypyrrole photoactive under visible light irradiation for methylene blue dye photodegradation,” Colloid and Polymer Science, 293(12):3459-3469 (2015).
(5) Zuo et al., “Influence of the backbone conformation of conjugated polymers on morphology and photovoltaic properties,” Polym. Chem., 5(6):1976-1981 (2014).
(6) Zhang et al., “P3HT/Ag/TiO2 ternary photocatalyst with significantly enhanced activity under both visible light and ultraviolet irradiation,” Applied Surface Science, 488:228-236 (2019).
(7) Zhang et al., “Dramatic Visible Photocatalytic Degradation Performances Due to Synergetic Effect of TiO2 with PANI,” Environmental Science & Technology, 42(10):3803-3807 (2008).
(8) Vidya and Balamurugan, “Photocatalytic degradation of methylene blue using PANi—NiO nanocomposite under visible light irradiation,” Materials Research Express, 6(9):0950c0958 (2019).
(9) Zhang et al., “Photocorrosion Inhibition and Photoactivity Enhancement for Zinc Oxide via Hybridization with Monolayer Polyaniline,” The Journal of Physical Chemistry C, 113(11):4605-4611 (2009).

Additionally, some general trends can also be highlighted in this comparison. A majority of the CP-MOₓ photocatalysis publications report the effects of the MOₓ/CP ratio. In most of these studies, the catalytic rate initially increases and then decreases with increasing MOₓ/CP, similar to inventors' observations (Zhang et al., “P3HT/Ag/TiO2 ternary photocatalyst with significantly enhanced activity under both visible light and ultraviolet irradiation,” Appl. Surf. Sci., 488:228-236 (2019); Zhang et al., “Dramatic Visible Photocatalytic Degradation Performances Due to Synergetic Effect of TiO2 with PANI,” Environ. Sci. Technol., 42(10):3803-3807 (2008)). The reason for the initial increase could simply be the increasing surface area of MOₓ, which appears to be the primary site for catalytic reactions to occur. Eventually, however, the photocatalyst may be limited by the amount of excitons able to reach the metal oxide catalyst sites.

Many of the lower performing photocatalysts have been made by coating CPs onto metal oxide particles ((Zhang et al., “P3HT/Ag/TiO2 ternary photocatalyst with significantly enhanced activity under both visible light and ultraviolet irradiation,” Appl. Surf. Sci., 488:228-236 (2019); Zhang et al., “Photocorrosion Inhibition and Photoactivity Enhancement for Zinc Oxide via Hybridization with Monolayer Polyaniline,” J. Phys. Chem. C, 113(11):4605-4611 (2009); Zhang et al., “Dramatic Visible Photocatalytic Degradation Performances Due to Synergetic Effect of TiO2 with PANI,” Environ. Sci. Technol., 42(10):3803-3807 (2008)) or synthesizing the CP with the MOₓ in large excess (Ovando-Medina et al., “Composite of acicular rod-like ZnO nanoparticles and semiconducting polypyrrole photoactive under visible light irradiation for methylene blue dye photodegradation,” Colloid Polym. Sci., 293(12):3459-3469 (2015)). These catalyst architectures would bury the metal oxide surface below the CP, making the catalytic sites less accessible to the chemicals being degraded. Conversely, many of the highest performing photocatalysts use thin CP coatings on a metal oxide (Dimitrijevic et al., “Nanostructured TiO2/Polypyrrole for Visible Light Photocatalysis,” J. Phys. Chem. C, 117(30):15540-15544 (2013)) or simply have the metal oxide exposed (inventors' work). Based on the inventors' understanding of the CP-MOₓ photocatalytic mechanism, FIGS. 17A-17E present various catalyst designs and their respective benefits and drawbacks. Based on XPS depth profiles for the VPI P3HT-TiOₓ hybrid catalysts described herein, VPI appears to generate a hybrid structure in which the metal oxide clusters are at or near the surface of the CP, thus achieving a design similar to that in FIG. 17E. To test the merit of this design, inventors sought to produce several other designs that are expected to be less optimal.

FIG. 18 presents the results of these different designs. Specifically, (1) 50-cycles of ALD-deposited TiO₂ recoated with neat P3HT and (2) P3HT exposed to 5 cycles of TiCl₄+H₂O VPI (inventors' nominal catalyst) recoated with neat P3HT were tested. These are compared to prior data for a pure TiOₓ ALD film and the 5 cycle VPI P3HT-TiOₓ catalyst. FIG. 18 clearly shows that both tests are less photocatalytic than the VPI-synthesized P3HT-TiOₓ and less photocatalytic than the ALD-deposited TiO₂ film. These results provide further evidence that a P3HT surface layer impedes overall photocatalytic performance because the metal oxide is no longer exposed to the reactant species. This requirement sets VPI apart as an effective method to achieve near-surface metal oxide sites, creating superior catalyst architectures. This difference in catalyst architecture is important to note; while prior CP-MOₓ photocatalysts have used similar chemistries (P3HT+TiO₂), the distributions have been more akin to those of composites or nanocomposites. Herein, atomic-scale clusters of titanium oxide mixed intimately within the P3HT chains is demonstrated. Likely, both this more intimate intermixing of organic and inorganic materials (which should facilitate photoelectron injection) and the localization of TiOₓ near the catalyst reaction surface (which makes interaction with the target dye molecules more direct) are contributing to the higher reactivity of this hybrid catalyst.

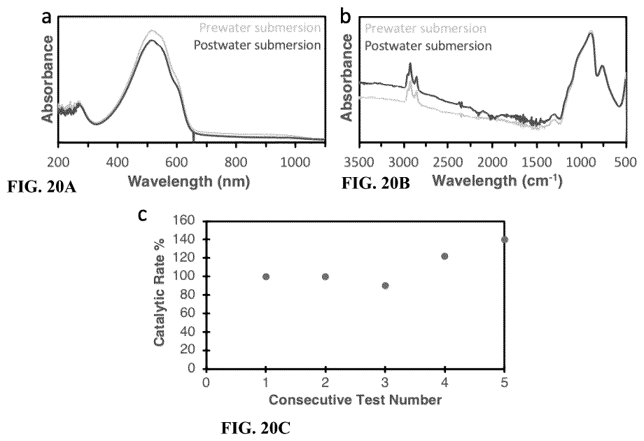

Finally, it is worth mentioning that highly effective photocatalysts are photostable and often nanostructured to increase the effective surface area. MOₓ materials are well known for their stability, but CPs can degrade in air or water environments. For example, P3HT is known to degrade over time when exposed to oxygen and light (Yaghoobi et al., “Impact of P3HT Regioregularity and Molecular Weight on the Efficiency and Stability of Perovskite Solar Cells,” ACS Sustainable Chemistry & Engineering, 9(14):5061-5073 (2021). To test the stability of the hybrid material made over the duration of the test period, FTIR and UV-Vis spectra (FIGS. 20A-20B) of the samples were taken before and after submerging the hybrid film in water under illumination for 4 hours, the length of time it would be submerged in a catalysis measurement. To ensure removal of any sorbed water from the films, the samples were placed under a 125 Torr vacuum for 24 hours after submersion then analyzed using the appropriate spectroscopic technique. As seen in FIGS. 20A-20B, the spectroscopic signatures of the hybrid film do not change significantly after water immersion and illumination. The UV-Vis spectra (FIG. 20A) show the same absorption pattern before and after water submersion, indicating the electronic structure of the P3HT did not change. The minor difference in the amount of absorption can simply be due to slight differences in film thickness. FTIR spectra show the same functional groups present without any notable changes to peak positions, intensities or emergences of new peaks. No change is observed in the FTIR and UV-vis spectra before and after a 4 h water submersion under illumination (FIGS. 20A-20B). Additionally, consecutive photocatalytic tests with the same sample showed that the catalyst can be reused and is recyclable (FIG. 20C). While P3HT will likely exhibit long term stability issues, more aqueous-stable CP has been demonstrated and could be of interest for the future development of hybrid photocatalysts (Holliday et al., “High-efficiency and air-stable P3HT-based polymer solar cells with a new non-fullerene acceptor,” Nat. Commun., 7(1):11585 (2016)). As a final test to the stability of the hybrid catalyst, the same catalyst was subjected to multiple catalytic rate tests. As can be seen in FIG. 20C, the catalytic rate of the sample measured remains relatively consistent through the 5 consecutive catalytic rate tests. Around the 4th catalytic test, the film begins to delaminate from the glass substrate, possibly artificially increasing the surface area which may explain the increase in catalytic rate. If further testing is to be done, either an adhesion layer or a different casting method will need to be used. Regardless, initial tests show the hybrid is rather stable in the given test conditions and the catalyst is generally recyclable. Of note, prior to the first catalytic test, the samples were presubmerged in a MB solution without illumination to allow for any reaction/sorption activities to occur. However, samples were not subjected to this presubmersion treatment after the first catalytic test, as it seemed reasonable that any reaction/sorption activities would have already occurred. The first 30 mins of absorption data collected was still ignored, as previously described. Although the catalyst was demonstrated to be stable for the measurement period studied, long-term stability issues for P3HT will still likely emerge over the course of weeks to months. Studies have been done to design solar cells where P3HT is stable even with light exposure (Holliday et al., “High-efficiency and air-stable P3HT-based polymer solar cells with a new non-fullerene acceptor,” Nat. Commun., 7(1):11585 (2016)). Alternatively, more air-stable conjugated polymers have also been synthesized by both modifying the CP backbone or the side chains (Tournebize et al., “Is there a photostable conjugated polymer for efficient solar cells?” Polymer Degradation and Stability, 112:175-184 (2015); Shen et al., “Enhancement of Photostability through Side Chain Tuning in Dioxythiophene-Based Conjugated Polymers,” Chemistry of Materials, 34(3):1041-1051 (2022). While inventors recognize these potential limitations for P3HT, its commercial availability and well-reported properties make it a good candidate for this initial demonstration. As for nanostructuring, inventors have chosen to focus on purely 2D P3HT films in this disclosure because of their simplicity in physical and chemical characterization. However, it is likely that much higher degradation rates can be achieved from these VPI P3HT-MOx hybrid photocatalysts if a nanostructured surface is used. Work has been done to attach P3HT polymer chains to nanoparticles (Kruger et al., “End-Group Functionalization of Poly(3-hexylthiophene) as an Efficient Route to Photosensitize Nanocrystalline TiO2 Films for Photovoltaic Applications,” ACS Appl. Mater. Interfaces, 3(6):2031-204168 (2011)) as well as make self-supported P3HT nanoparticles (Tran et al., “Graphene Nanosheets Stabilized by P3HT Nanoparticles for Printable Metal-Free Electrocatalysts for Oxygen Reduction,” ACS Appl. Nano Mater., 6(2):908-917 (2023), so this opens the possibility for much higher-performing designs.

The present disclosure demonstrates that the VPI of P3HT with TiCl₄ and H₂O can be used to synthesize an organic-inorganic hybrid photocatalyst material. XPS shows that the infiltrated inorganic primarily exists as oxidized titania and that the conjugated polymer is doped during the VPI process. The hybrid material can be significantly more photocatalytically active than either the polymer or metal oxide individually when illuminated. Combined with the PL quenching observed for the P3HT-TiOₓ hybrids, these results provide strong evidence that P3HT is acting as a good photosensitizer for the infiltrated TiOₓ inorganics. Through doping and dedoping studies, it was demonstrated that higher electrical conductivity alone is not sufficient to explain the observed photocatalytic enhancement, but rather that the presence of the TiOₓ inorganic is essential. When comparing the hybrid material made by VPI to other CP-MOₓ photocatalysts, good catalyst architecture design seems to include keeping the MOₓ catalyst near the reactive surface, as accomplished here. Control studies reaffirm that having the metal oxide near the CP's surface, as is the nature of VPI, is critical to achieving the highest photocatalytic activities. In total, these results introduce a new approach for creating high-performing organic-inorganic hybrid materials for photocatalytic degradation of chemical contaminants.

What is claimed is:

1. A photocatalyst system comprising:
a photocatalyst comprising an organic material infused with clusters of an inorganic material diffused throughout a bulk of the organic material, wherein the organic material and the clusters of the inorganic material are configured such that the organic material photosensitizes the inorganic material.

2. The photocatalyst system of claim 1 further comprising a light source.

3. The photocatalyst system of claim 1, wherein the organic material is infused with the inorganic material via vapor phase infiltration process.

4. The photocatalyst system of claim 1, wherein the organic material comprises a conjugated, conducting polymer.

5. The photocatalyst system of claim 4, wherein the conjugated, conducting polymer is poly(3-hexylthiophene-2,5-diyl) (P3HT).

6. The photocatalyst system of claim 1, wherein the organic material has a band gap of 1 eV to 3 eV.

7. The photocatalyst system of claim 1, wherein the inorganic material comprises a metal oxide.

8. The photocatalyst system of claim 7, wherein the metal oxide is selected from the group consisting of titanium oxide, vanadium oxide, zinc oxide, tin oxide, cerium oxide, iron (III) oxide, chromium oxide.

9. The photocatalyst system of claim 1, further comprising a nanostructured surface.

10. The photocatalyst system of claim 1, wherein the photocatalyst is more photocatalytically active than either the organic material or inorganic material individually.

11. The photocatalyst system of claim 1, wherein the photocatalyst is an organic-inorganic hybrid photocatalyst.

12. The photocatalyst system of claim 1, wherein the inorganic material is at or near the surface of the organic material.

13. The photocatalyst system of claim 2, wherein the light source comprises visible light.

14. A method of photocatalyzing a reaction comprising:
providing a photocatalyst comprising an organic material infused with clusters of an inorganic material diffused throughout a bulk of the organic material, wherein the organic material and the clusters of the inorganic material are configured such that the organic material photosensitizes the inorganic material;
mixing the photocatalyst with a reactant to form a reaction mixture; and
exposing the reaction mixture to a light source.

15. The method of claim 14, wherein the reactant is an organic compound.

16. The method of claim 15, wherein the organic compound is a dye.

17. The method of claim 14, wherein providing the photocatalyst comprises:
providing an organic material;
providing an inorganic material; and
dosing the organic material with the inorganic material via vapor phase infiltration.

18. The method of claim 14, wherein the light source comprises visible light.

19. The method of claim 14, wherein the organic material comprises a conjugated, conducting polymer.

20. The method of claim 14, wherein inorganic material comprises a metal oxide.
